(19) United States
(12) Patent Application Publication
(10) Pub. No.: US 2025/0016543 A1
(43) Pub. Date: Jan. 9, 2025

(54) DATA COLLECTION METHOD AND COMMUNICATION DEVICE

(71) Applicant: VIVO MOBILE COMMUNICATION CO., LTD., Dongguan (CN)

(72) Inventors: Huazhang LV, Dongguan (CN); Xiaowan KE, Dongguan (CN); Weiwei CHONG, Dongguan (CN)

(73) Assignee: VIVO MOBILE COMMUNICATION CO., LTD., Dongguan (CN)

(21) Appl. No.: 18/890,745

(22) Filed: Sep. 19, 2024

Related U.S. Application Data
(63) Continuation of application No. PCT/CN2023/082566, filed on Mar. 20, 2023.

(30) Foreign Application Priority Data
Mar. 21, 2022 (CN) 202210281233.8

(51) Int. Cl. H04W 8/14; H04W 24/10; H04W 28/20

(52) U.S. Cl. CPC H04W 8/14; H04W 24/10; H04W 28/20

(57) ABSTRACT

This application discloses a data collection method and a communication device. The data collection method includes: A first communication device sends a first request to a target communication device, where the first request is used to request to obtain target data collected by a third communication device corresponding to a target terminal, and the target data is used by the first communication device to perform target processing; and the first communication device obtains the target data collected by the third communication device.

### CROSS-REFERENCE TO RELATED APPLICATIONS

This application is a continuation of International Application No. PCT/CN2023/082566, filed Mar. 20, 2023, which claims priority to Chinese Patent Application No. 202210281233.8, filed Mar. 21, 2022. The entire contents of each of the above-referenced applications are expressly incorporated herein by reference.

### TECHNICAL FIELD

This application relates to the field of communication technologies, and specifically relates to a data collection method and a communication device.

### BACKGROUND

A Network Data Analytics Function (NWDAF) automatically senses and analyzes a network based on network data, and participates in an entire lifecycle of network planning, construction, operation and maintenance, network optimization, and operation, so that it is easy to maintain and control the network, network resource use efficiency is improved, and service experience of users is improved.

The NWDAF can provide a plurality of analytics functions, such as an observed service experience analytics function (Observed Service Experience related network data analytics). In this function, quality of service QoS information, such as an uplink/downlink rate and a packet loss rate, of accessing a specific server by a terminal needs to be collected, and one piece of statistics information may be output. The statistics information includes user experience of accessing the server by the terminal. To implement the observed service experience analytics function, the NWDAF needs to collect related data from some devices such as a core network function, a third-party server, or a terminal. For example, data needs to be collected from a User Plane Function (UPF). Therefore, for a person skilled in the art, how to collect data from the UPF is a technical problem that needs to be urgently resolved.

### SUMMARY

Embodiments of this application provide a data collection method and a communication device.

According to a first aspect, a data collection method is provided and is applied to a first communication device, and the method includes:
sending a first request to a target communication device, where the first request is used to request to obtain target data collected by a third communication device corresponding to a target terminal, and the target data is used by the first communication device to perform target processing; and
obtaining the target data collected by the third communication device.

According to a second aspect, a data collection method is provided and is applied to a second communication device, and the method includes:
receiving a first request sent by a first communication device, where the first request is used to request to obtain target data collected by a third communication device corresponding to a target terminal, and the target data is used by the first communication device to perform target processing.

According to a third aspect, a data collection method is provided and is applied to a third communication device, and the method includes:
receiving a target request, where the target request is used to request the third communication device to collect target data and/or obtain target data collected by the third communication device, and the target data is used by a first communication device to perform target processing.

According to a fourth aspect, a data collection method is provided and is applied to a fourth communication device, and the method includes:
receiving a third request sent by a first communication device, where the third request is used to request to obtain information about a target communication device corresponding to at least one target terminal, the target communication device includes a second communication device and/or a third communication device, the information about the target communication device is used by the first communication device to obtain target data collected by a third communication device corresponding to each target terminal, and the target data is used by the first communication device to perform target processing.

According to a fifth aspect, a data collection method is provided and is applied to a fifth communication device, and the method includes:
receiving a policy generation request sent by a second communication device, where the policy generation request is used to request the fifth communication device to generate a target policy control rule corresponding to a third communication device, and the target policy control rule is used to indicate a type of collected data; and
sending the target policy control rule corresponding to the third communication device to the second communication device.

According to a sixth aspect, a data collection apparatus is provided, and includes:
a sending module, configured to send a first request to a target communication device, where the first request is used to request to obtain target data collected by a third communication device corresponding to a target terminal, and the target data is used by a first communication device to perform target processing; and
an obtaining module, configured to obtain the target data collected by the third communication device.

According to a seventh aspect, a data collection apparatus is provided, and includes: a receiving module, configured to receive a first request sent by a first communication device, where the first request is used to request to obtain target data collected by a third communication device corresponding to a target terminal, and the target data is used by the first communication device to perform target processing.

According to an eighth aspect, a data collection apparatus is provided, and includes:
a receiving module, configured to receive a target request, where the target request is used to request a third communication device to collect target data and/or obtain target data collected by the third communication device, and the target data is used by a first communication device to perform target processing.

According to a ninth aspect, a data collection apparatus is provided, and includes:
a receiving module, configured to receive a third request sent by a first communication device, where the third request is used to request to obtain information about a target communication device corresponding to at least one target terminal, the target communication device includes a second communication device and/or a third communication device, the information about the target communication device is used by the first communication device to obtain target data collected by a third communication device corresponding to each target terminal, and the target data is used by the first communication device to perform target processing.

According to a tenth aspect, a data collection apparatus is provided, and includes:
a receiving module, configured to receive a policy generation request sent by a second communication device, where the policy generation request is used to request a fifth communication device to generate a target policy control rule corresponding to a third communication device, and the target policy control rule is used to indicate a type of collected data; and
a sending module, configured to send the target policy control rule corresponding to the third communication device to the second communication device.

According to an eleventh aspect, a first communication device is provided. The first communication device includes a processor and a memory, the memory stores a program or an instruction that can be run on the processor, and when the program or the instruction is executed by the processor, the method according to the first aspect is implemented.

According to a twelfth aspect, a first communication device is provided, including a processor and a communication interface. The communication interface is configured to send a first request to a target communication device, where the first request is used to request to obtain target data collected by a third communication device corresponding to a target terminal, and the target data is used by the first communication device to perform target processing. The processor is configured to obtain the target data collected by the third communication device.

According to a thirteenth aspect, a second communication device is provided. The second communication device includes a processor and a memory, the memory stores a program or an instruction that can be run on the processor, and when the program or the instruction is executed by the processor, the method according to the second aspect is implemented.

According to a fourteenth aspect, a second communication device is provided, including a processor and a communication interface. The communication interface is configured to receive a first request sent by a first communication device, where the first request is used to request to obtain target data collected by a third communication device corresponding to a target terminal, and the target data is used by the first communication device to perform target processing.

According to a fifteenth aspect, a third communication device is provided. The third communication device includes a processor and a memory, the memory stores a program or an instruction that can be run on the processor, and when the program or the instruction is executed by the processor, the method according to the third aspect is implemented.

According to a sixteenth aspect, a third communication device is provided, including a processor and a communication interface. The communication interface is configured to receive a target request, where the target request is used to request a third communication device to collect target data and/or obtain target data collected by the third communication device, and the target data is used by a first communication device to perform target processing.

According to a seventeenth aspect, a fourth communication device is provided. The fourth communication device includes a processor and a memory, the memory stores a program or an instruction that can be run on the processor, and when the program or the instruction is executed by the processor, the method according to the fourth aspect is implemented.

According to an eighteenth aspect, a fourth communication device is provided, including a processor and a communication interface. The communication interface is configured to receive a third request sent by a first communication device, where the third request is used to request to obtain information about a target communication device corresponding to at least one target terminal, the target communication device includes a second communication device and/or a third communication device, the information about the target communication device is used by the first communication device to obtain target data collected by a third communication device corresponding to each target terminal, and the target data is used by the first communication device to perform target processing.

According to a nineteenth aspect, a fifth communication device is provided. The fifth communication device includes a processor and a memory, the memory stores a program or an instruction that can be run on the processor, and when the program or the instruction is executed by the processor, the method according to the fifth aspect is implemented.

According to a twentieth aspect, a fifth communication device is provided, including a processor and a communication interface. The communication interface is configured to receive a policy generation request sent by a second communication device, where the policy generation request is used to request the fifth communication device to generate a target policy control rule corresponding to a third communication device, and the target policy control rule is used to indicate a type of collected data. The processor is configured to send the target policy control rule corresponding to the third communication device to the second communication device.

According to a twenty-first aspect, a communication system is provided, including a first communication device, a second communication device, a third communication device, a fourth communication device, and a fifth communication device. The first communication device may be configured to perform the data collection method according to the first aspect, the second communication device may be configured to perform the data collection method according to the second aspect, the third communication device may be configured to perform the data collection method according to the third aspect, the fourth communication device may be configured to perform the data collection method according to the fourth aspect, and the fifth communication device may be configured to perform the data collection method according to the fifth aspect.

According to a twenty-second aspect, a readable storage medium is provided. The readable storage medium stores a program or an instruction, and when the program or the instruction is executed by a processor, the steps of the method according to the first aspect are implemented, the steps of the method according to the second aspect are implemented, the steps of the method according to the third aspect are implemented, the steps of the method according to the fourth aspect are implemented, or the steps of the method according to the fifth aspect are implemented.

According to a twenty-third aspect, a chip is provided. The chip includes a processor and a communication interface, the communication interface is coupled to the processor, and the processor is configured to run a program or an instruction to implement the method according to the first aspect, the method according to the second aspect, the method according to the third aspect, the method according to the fourth aspect, or the method according to the fifth aspect.

According to a twenty-fourth aspect, a computer program/program product is provided. The computer program/program product is stored in a storage medium, and the computer program/program product is executed by at least one processor to implement the data collection method according to the first aspect, the second aspect, the third aspect, the fourth aspect, or the fifth aspect.

In the embodiments of this application, a first communication device sends a first request to a target communication device, where the first request is used to request to obtain target data collected by a third communication device corresponding to a target terminal, and the target data is used by the first communication device to perform target processing; and the first communication device obtains the target data collected by the third communication device. In other words, the first communication device may send a request to the target communication device to obtain the target data collected by the third communication device. The target communication device may be a second communication device or may be the third communication device. In other words, the first communication device may directly send a request to the third communication device to obtain the target data collected by the third communication device, or may send a request to the second communication device to finally obtain the target data collected by the third communication device. An implementation process is simple, highly flexible, and efficient.

### BRIEF DESCRIPTION OF DRAWINGS

FIG. 1 is a structural diagram of a wireless communication system to which embodiments of this application can be applied;

FIG. 2 is a first schematic flowchart of a data collection method according to an embodiment of this application;

FIG. 3 to FIG. 11 are schematic diagrams of interaction procedures of a data collection method according to an embodiment of this application;

FIG. 12 is a second schematic flowchart of a data collection method according to an embodiment of this application;

FIG. 13 is a third schematic flowchart of a data collection method according to an embodiment of this application;

FIG. 14 is a fourth schematic flowchart of a data collection method according to an embodiment of this application;

FIG. 15 is a fifth schematic flowchart of a data collection method according to an embodiment of this application;

FIG. 16 is a first schematic diagram of a structure of a data collection apparatus according to an embodiment of this application;

FIG. 17 is a second schematic diagram of a structure of a data collection apparatus according to an embodiment of this application;

FIG. 18 is a third schematic diagram of a structure of a data collection apparatus according to an embodiment of this application;

FIG. 19 is a fourth schematic diagram of a structure of a data collection apparatus according to an embodiment of this application;

FIG. 20 is a fifth schematic diagram of a structure of a data collection apparatus according to an embodiment of this application;

FIG. 21 is a schematic diagram of a structure of a communication device according to an embodiment of this application;

FIG. 22 is a schematic diagram of a hardware structure of a terminal according to an embodiment of this application; and

FIG. 23 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the term NR is used in most of the following description, although these technologies can also be applied to applications other than the NR system application, such as the 6^{th} generation (6G) communication system.

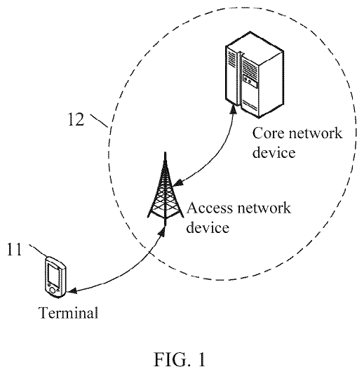

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle-mounted user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a WiFi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art, provided that the same technical effect is achieved. The base station is not limited to a specific technical vocabulary. It should be noted that in the embodiments of this application, a base station in an NR system is merely used as an example for description, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a local NEF (L-NEF), a Binding Support Function (BSF), an Application Function (AF), or the like. It should be noted that, in the embodiments of this application, only a core network device in the NR system is used as an example for description, and a specific type of the core network device is not limited.

Currently, in a 3rd Generation Partnership Project (3GPP), a Network Data Analytics Function (NWDAF) is introduced to perform some intelligent analysis. The NWDAF has a specific artificial intelligence analytics function. The NWDAF collects some data and performs analysis by using a built-in algorithm and analysis capability to obtain a result, and provides the result for a core network function for operation optimization or statistical analysis. A network data analytics function automatically senses and analyzes a network based on network data, and participates in an entire lifecycle of network planning, construction, operation and maintenance, network optimization, and operation, so that it is easy to maintain and control the network, network resource use efficiency is improved, and service experience of users is improved.

The NWDAF can provide an observed service experience related network data analytics function. In this function, Quality of Service (QoS) information, such as an uplink/downlink rate and a packet loss rate, of a terminal accessing a server can be collected, and one piece of statistical information can be output. The information includes user experience of accessing the server by the terminal. The NWDAF may also perform prediction based on a historical experience status of accessing the server by the terminal, for example, a possible user experience status in a case that the terminal accesses the server in a specific area in a future time period.

Generally, analysis or prediction content that can be provided by the NWDAF is distinguished by an analytic identifier (Analytic ID). By indicating different analytic IDs and some parameters to the NWDAF, the NWDAF may provide an analysis and prediction result corresponding to the analytic identifiers. However, the NWDAF needs to collect related data from some core network functions, third-party servers, or terminals to complete the analysis or prediction. For example, for the foregoing observed service experience related network data analytics, data needs to be collected from a User Plane Function (UPF). As for how to collect data from the UPF, there are some unresolved problems:

Currently, 3GPP only specifies an analytic ID, that is, what data needs to be collected by the NWDAF from the UPF under what prediction and analysis, but as for how to find the UPF and how the NWDAF collects the data from the UPF, no process and no method are described. For example, for the foregoing observed service experience related network data analytics, data shown in Table 1 needs to be collected from the UPF.

TABLE 1

| | |
|---|---|
| QoS flow bit rate | The observed bit rate for UL direction, and the |
| QoS flow Bit Rate | observed bit rate for DL direction |
| | The observed bit rate for UL direction, and the |
| | observed bit rate for DL direction. |
| QoS flow | The observed Packet delay for UL direction, and |
| packet delay | the observed Packet delay for the DL direction |
| QoS flow | The observed Packet delay for UL direction, and |
| Packet Delay | the observed Packet delay for the DL direction. |
| Packet transmission | The observed number of packet transmission |
| Packet transmission | The observed number of packet transmission. |
| Packet retransmission | The observed number of packet retransmission |
| Packet retransmission | The observed number of packet retransmission. |

However, how to find the corresponding UPF and how to collect data from the UPF are unknown.

In addition, the UPF is a non-serving function or a function with a limited service degree. Only a Session Management Function (SMF) controls the UPF, and another function in a core network of a fifth generation (5G) mobile communication system cannot directly or indirectly collect data from the UPF by using a service message.

In other words, to implement the observed service experience related network data analytics function (not limited to the analytics), the NWDAF needs to collect related data from some devices such as a core network function, a third-party server, or a terminal, for example, needs to collect data from the UPF. However, currently, 3GPP only specifies an analytic ID, that is, what data needs to be collected from the UPF under what prediction and analysis, but as for how to collect the data from the UPF, no process and no method are described. Therefore, for a person skilled in the art, how to collect data from the UPF is a technical problem that needs to be urgently resolved.

In the data collection method in the embodiments of the present application, a first communication device sends a first request to a target communication device, where the first request is used to request to obtain target data collected by a third communication device corresponding to a target terminal, and the target data is used by the first communication device to perform target processing; and the first communication device obtains the target data collected by the third communication device. In other words, the first communication device may send a request to the target communication device to obtain the target data collected by the third communication device. The target communication device may be a second communication device or may be the third communication device. In other words, the first communication device may directly send a request to the third communication device to obtain the target data collected by the third communication device, or may send a request to the second communication device to finally obtain the target data collected by the third communication device. An implementation process is simple, highly flexible, and efficient.

The data collection methods provided in the embodiments of this application are described in detail below with reference to the accompanying drawings by using some embodiments and application scenarios thereof.

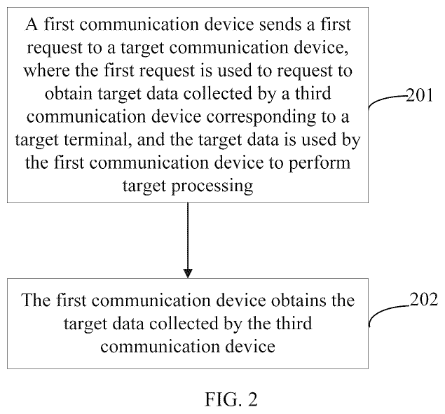

FIG. 2 is a first schematic flowchart of a data collection method according to an embodiment of this application. As shown in FIG. 2, the method provided in this embodiment includes the following steps:

Step 201: A first communication device sends a first request to a target communication device, where the first request is used to request to obtain target data collected by a third communication device corresponding to a target terminal, and the target data is used by the first communication device to perform target processing.

In some embodiments, the first communication device may be a network data analytics function NWDAF, and the target communication device may be a session management function SMF or a user plane function UPF.

The NWDAF automatically senses and analyzes a network based on network data, and participates in an entire lifecycle of network planning, construction, operation and maintenance, network optimization, and operation, so that it is easy to maintain and control the network, network resource use efficiency is improved, and service experience of users is improved. Generally, the NWDAF needs to collect related data from some core network functions, third-party servers, or terminals to complete the analysis or prediction. For example, for observed service experience related network data analytics, the NWDAF needs to collect data from a user plane function UPF, but currently, how to obtain data collected by the UPF has not been clarified in 3GPP. In this embodiment of this application, to obtain the target data collected by the third communication device, the first communication device may send the first request to the target communication device, so as to request to obtain the target data collected by the third communication device corresponding to the target terminal. The target terminal may be a terminal whose traffic data needs to be analyzed by the NWDAF, and the third communication device corresponding to the target terminal may mean that the third communication device carries a PDU session of the target terminal or a PDU session is established between the target terminal and the third communication device. The target communication device may be a second communication device SMF or may be the third communication device UPF. In other words, the first communication device NWDAF may directly send the first request to the third communication device UPF to directly obtain the target data collected by the third communication device, or may send the first request to the second communication device SMF to finally obtain the target data collected by the third communication device. For example, if a PDU session of a specific target terminal=1, this session is carried by the third communication device UPF, and a specific server IP address can be accessed by using the PDU session, the UPF is a UPF from which data needs to be collected.

For example, the first communication device may send the first request to the second communication device or the third communication device to request to obtain the target data collected by the third communication device. In other words, the NWDAF may directly send the first request to the UPF, to obtain the target data from the UPF. The NWDAF may send the first request to the second communication device SMF, to obtain the target data from the third communication device UPF. For example, the second communication device SMF forwards, by interacting with the third communication device UPF, the target data collected by the third communication device UPF to the first communication device, or the third communication device UPF directly sends the collected target data to the first communication device.

Step 202: The first communication device obtains the target data collected by the third communication device.

In some embodiments, after the first communication device obtains, by sending the first request, the target data collected by the third communication device, the first communication device may perform corresponding target processing based on the obtained target data, to complete automatic network sensing, analysis, and network operation optimization. In some embodiments, the first communication device may directly obtain the target data from the third communication device, or may obtain the target data collected by the third communication device and forwarded by the second communication device.

In the method in the foregoing embodiment, a first communication device sends a first request to a target communication device, where the first request is used to request to obtain target data collected by a third communication device corresponding to a target terminal, and the target data is used by the first communication device to perform target processing; and the first communication device obtains the target data collected by the third communication device. In other words, the first communication device may send a request to the target communication device to obtain the target data collected by the third communication device. The target communication device may be a second communication device or may be the third communication device. In other words, the first communication device may directly send a request to the third communication device to obtain the target data collected by the third communication device, or may send a request to the second communication device to finally obtain the target data collected by the third communication device. An implementation process is simple, highly flexible, and efficient.

In some embodiments, the first request includes at least one of the following: a terminal identifier, a Data Network Name (DNN), a Packet Data Unit (PDU) session identifier, Single Network Slice Selection Assistance Information (S-NSSAI), an application identifier, an analytic identifier, an event identifier, a type of the target data, a Data Network Access Identifier (DNAI), a packet detection rule (PDR), or a quality of service QoS flow identifier (QFI), where the analytic identifier and the event identifier are used to indicate a type of the collected target data, and the analytic identifier corresponds to at least one event identifier. The PDR is used by the third communication device to collect data of different target data types.

The first request may be but is not limited to at least one of the following:
Nsmf_EventExposure_Subscribe; or
Nupf_EventExposure_Subscribe.

In some embodiments, by sending content included in the first request, the first communication device may clearly indicate and notify the third communication device of the target data to be collected, that is, the target data required by the first communication device can be accurately determined based on the first request sent by the first communication device, and therefore, data can be accurately collected based on the first request. In this way, the first communication device can obtain the required target data.

In other words, third communication devices from which data need to be determined and specific data can be clearly and accurately determined by using the first request, so that data collection is more targeted and more efficient.

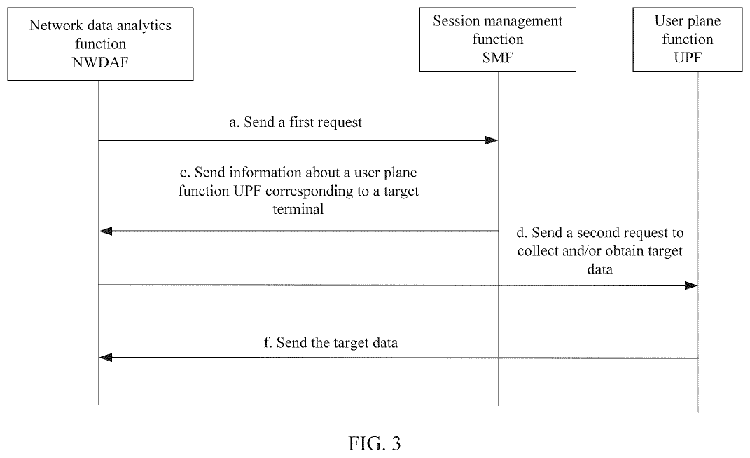

In some embodiments, as shown in FIG. 3, in a case that the target communication device is the second communication device, that is, the first communication device sends the first request to the second communication device, the method further includes:
receiving, by the first communication device, information about the third communication device that is sent by the second communication device, for example, by using Nsmf_EventExposure_Notify.

The first communication device sends a second request to the third communication device based on the information about the third communication device. The second request is used to request the third communication device to collect the target data and/or obtain the target data collected by the third communication device. For example, the second request may be Nupf_EventExposure_Subscribe.

In a case that the second request is used to request to obtain the target data collected by the third communication device, that the first communication device obtains the target data collected by the third communication device includes:
the first communication device receives the collected target data sent by the third communication device, for example, by using Nupf_EventExposure_Notify.

In some embodiments, in a case that the target communication device is the second communication device (for example, an SMF), the first communication device sends the first request to the second communication device (step a), the second communication device obtains the information about the third communication device based on the first request, and the second communication device sends the information about the third communication device to the first communication device (step c), and the first communication device receives the information about the third communication device that is sent by the second communication device, and the first communication device sends the second request to the third communication device based on the information about the third communication device (step d). The second request is used to request the third communication device to collect the target data and/or obtain the target data collected by the third communication device. For example, after receiving information about the UPF that is sent by the SMF, the NWDAF sends the second request to the UPF based on the information about the UPF, to request the UPF to collect the target data and/or obtain the target data collected by the UPF, that is, the second communication device SMF controls the third communication device UPF, so that the first communication device may request, based on the information about the third communication device that is obtained by the second communication device, the third communication device UPF to collect and/or obtain the target data.

In some embodiments, the information about the third communication device includes at least one of the following:
an IP address, an instance identifier, a fully qualified domain name (FQDN), a QoS flow identifier QFI, a PDR, or a PDU session identifier.

In other words, the information about the third communication device is used to identify the third communication device UPF or indicate an identifier of a PDU session established between the target terminal and the third communication device. To be specific, the first communication device may accurately determine, by receiving the information about the third communication device that is sent by the second communication device, a third communication device to which the request is to be sent, to collect and/or obtain the target data. The PDU session identifier and the QFI are identifiers of QoS flows or PDU sessions that are determined by the SMF and that include to-be-collected data. After the information is provided for the UPF, the UPF may directly collect data by using a PDR in a QoS flow corresponding to the PDU session or the QFI.

In some embodiments, the second request includes at least one of the following: a terminal identifier, a data network name DNN, a packet data unit PDU session identifier, single network slice selection assistance information S-NSSAI, an application server IP address, an application identifier, an analytic identifier, an event identifier, a type of the target data, a data network access identifier DNAI, a packet detection rule PDR, or a quality of service QoS flow identifier QFI, where the analytic identifier and the event identifier are used to indicate a type of the collected target data, and the analytic identifier corresponds to at least one event identifier.

The second request may be the following signaling: Nupf_EventExposure_Subscribe.

In other words, the first communication device NWDAF sends the second request to the third communication device UPF, where the second request is used to request the third communication device to collect the target data and/or obtain the target data collected by the third communication device; and the third communication device may accurately determine, based on the second request sent by the first communication device, data that needs to be collected or sent to the first communication device, so that the first communication device can obtain the target data and perform analysis and processing.

For example, the information about the UPF device that is sent by the second communication device SMF and received by the first communication device NWDAF is A. For example, the information includes an ID of the UPF, an IP address of the UPF, and the like. To be specific, after the second communication device sends the information A about the third communication device UPF to the first communication device NWDAF, the first communication device NWDAF may send the second request to the third communication device UPF based on the information A about the third communication device UPF, to request the third communication device UPF to collect the target data and/or to request to obtain the target data collected by the third communication device. In this way, the first communication device can receive the target data sent by the third communication device UPF based on the foregoing request.

According to the method in the foregoing embodiment, after receiving the information about the third communication device that is sent by the second communication device, the first communication device may send the second request to the third communication device, to request the third communication device to collect the target data and/or obtain the target data collected by the third communication device. In this way, the target data is collected and obtained. An implementation is simple and convenient, and efficiency is high.

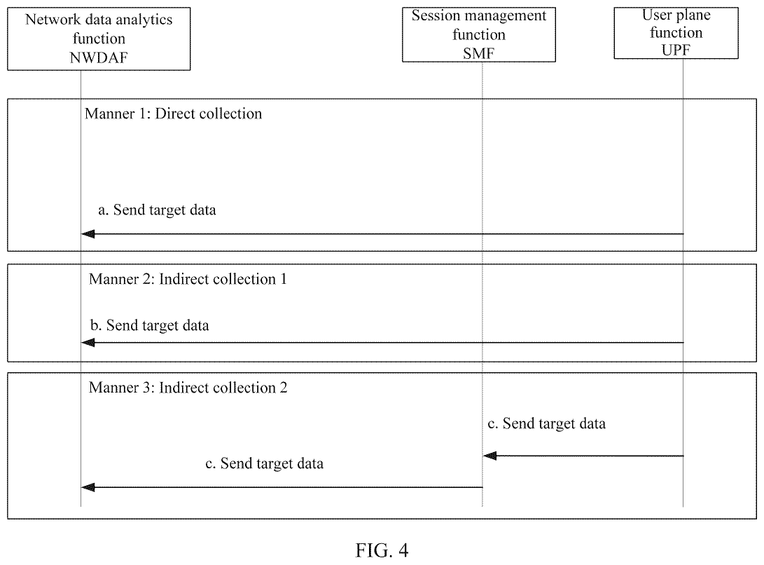

In an embodiment, as shown in FIG. 4, in a case that the target communication device is the second communication device, that the first communication device obtains the target data collected by the third communication device includes:
the first communication device receives the collected target data sent by the third communication device; or
the first communication device receives the target data sent by the second communication device and collected by the third communication device.

In some embodiments, in a case that the target communication device is the second communication device, the first communication device sends the first request to the second communication device. For example, the first request isNsmf_EventExposure_Subscribe. After receiving the first request, the second communication device may obtain the information about the third communication device, and further request the third communication device to collect the target data. For example, the second communication device notifies, by sending a subscription message, the third communication device to collect the target data. For example, the SMF sends a request Nupf_EventExposure_Subscribe to request the UPF to collect data. After collecting the target data, the third communication device may directly send the target data to the first communication device, for example, directly send Nupf_EventExposure_Notify (which carries the collected data) to the NWDAF; or the third communication device may send the target data to the second communication device, and the second communication device forwards the target data to the first communication device, for example, the UPF sends Nupf_EventExposure_Subscribe that carries the collected data to the SMF, and then the SMF sends the collected data to the NWDAF by using Nsmf_EventExposure_Notify. In other words, the first communication device may obtain the target data by receiving the collected target data sent by the third communication device or by receiving the target data sent by the second communication device and collected by the third communication device.

For example, in a case that the target communication device is the second communication device, that is, in a case that the target communication device is the SMF, after the first communication device NWDAF sends the first request to the second communication device SMF, the first communication device may obtain the target data by receiving the collected target data sent by the third communication device UPF or by receiving the target data sent by the second communication device SMF and collected by the third communication device UPF.

In the method in the foregoing embodiment, in a case that the target communication device is the second communication device, after sending the first request to the second communication device, the first communication device may receive the collected target data sent by the third communication device, or receive the target data sent by the second communication device and collected by the third communication device. In other words, a plurality of methods for obtaining the target data are provided. An implementation is simple, flexible, and diverse.

In an embodiment, in a case that the target communication device is the third communication device, that the first communication device obtains the target data collected by the third communication device includes:
the first communication device receives the collected target data sent by the third communication device.

For example, the first communication device collects data from the third communication device by using Nupf_EventExposure_Notify.

In some embodiments, in a case that the target communication device is the third communication device, the first communication device sends the first request to the target communication device, that is, in a case that the first communication device learns the information about the third communication device, the first communication device may directly send the first request to the third communication device to request to obtain the target data collected by the third communication device corresponding to the target terminal. After the third communication device completes data collection based on the first request sent by the first communication device, the first communication device may obtain the target data by receiving the collected target data sent by the third communication device.

For example, after the first communication device directly sends the first request to the third communication device UPF, and after the UPF collects the target data based on the first request, the first communication device NWDAF may obtain the target data by receiving the collected target data sent by the third communication device UPF.

In the method in the foregoing embodiment, in a case that the target communication device is the third communication device, the first communication device directly sends the first request to the third communication device to request to obtain the target data collected by the third communication device corresponding to the target terminal. In other words, the first communication device directly interacts with the third communication device, so that the collected target data sent by the third communication device can be quickly and conveniently obtained, thereby improving efficiency of obtaining the target data by the first communication device.

In some embodiments, in a case that the target communication device is the third communication device, the first request is further used to request the third communication device to collect the target data.

In some embodiments, the first request may be further used to request the third communication device to collect the target data, that is, the first communication device sends the first request to the target communication device, to request the third communication device to collect the target data. When the first communication device needs to perform data analysis, the first communication device obtains the target data from the third communication device and analyzes the target data.

For example, in a case that the target communication device is the third communication device or the target communication device is the second communication device, the first communication device may send the first request, to request the third communication device to collect target data from 8 a.m. to 8 p.m., and the first communication device may obtain the target data at 10 p.m. or another time according to a requirement. In other words, the first communication device may send the first request, so that the third communication device performs data collection in advance. When the first communication device needs to perform data analysis, the first communication device may directly obtain, from the third communication device, the target data that has been collected before. Therefore, efficiency is improved.

In the method in the foregoing embodiment, the first communication device sends the first request to request the third communication device to collect the target data. In other words, the first communication device may send the first request to enable the third communication device to perform data collection in advance. When the first communication device needs to perform data analysis, the first communication device may directly obtain, from the third communication device, the target data that has been collected before. Therefore, efficiency is improved.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, or data network performance analysis.

The target processing is an analysis or prediction function that can be completed by the NWDAF by using data collected by the UPF.

In some embodiments, after obtaining the target data collected by the third communication device, the first communication device may perform target processing based on the obtained target data, that is, may perform analysis and statistics collection of a corresponding dimension on the obtained target data, that is, may discover a network feature and problem from a plurality of dimensions based on the obtained target data, thereby providing rich and sufficient support for network optimization and maintenance.

According to the method in the foregoing embodiment, a network feature, user perception, and a network problem can be analyzed through the target processing on the target data, thereby providing rich and sufficient support for network optimization and maintenance.

In an embodiment, the target data is collected by the third communication device based on a target policy control rule, and the target policy control rule is used to indicate a type of the collected data.

In some embodiments, the third communication device may collect the target data based on the target policy control rule, where the target policy control rule is used to indicate a type of data collected by the third communication device.

For example, the PCF formulates a target policy control rule for collecting data by the UPF, and sends the target policy control rule to the SMF. After receiving the target policy control rule, the SMF sends the target policy control rule to the third communication device. In this case, after receiving the target policy control rule sent by the second communication device, the third communication device may collect data of a related type according to an instruction of the target policy control rule. In some embodiments, the target policy control rule includes, for example, data collection time information, data collection frequency information, and collected content. The collected content is the target data collected or obtained by the third communication device. The collected content may include at least one of the following: network data related to observed service experience, data related to terminal communication analysis, data related to user data congestion, data related to deviation analysis, or data related to wireless WLAN performance. The content collected above is all data that needs to be collected by the UPF. In addition, the data is an important guarantee for the NWDAF to generate a related analysis or prediction result.

According to the method in the foregoing embodiment, the third communication device may accurately determine, based on the target policy control rule, types of data that needs to be collected. In other words, the third communication device can collect the target data by using the target policy control rule. An implementation is simple and efficiency is high.

In some embodiments, the target policy control rule includes at least one of the following information:
a terminal identifier, an analytic identifier, an event identifier, PDU session information, data collection time information, data collection frequency information, or the type of the collected data.

In some embodiments, the target policy control rule includes at least one of the following information: a terminal identifier, an analytic identifier, an event identifier, PDU session information, data collection time information, data collection frequency information, or the type of the collected data. The third communication device may accurately determine, based on the target policy control rule, the target data to be collected. An implementation is simple and is easy to operate.

In some embodiments, the type of the collected data includes at least one of the following: network data analysis related to observed service experience, terminal communication analysis, user data congestion, deviation analysis, or wireless WLAN performance.

The network data analysis related to observed service experience includes at least one of the following data: a QoS flow bit rate, a QoS flow packet delay, a quantity of transmitted packets, or a quantity of retransmitted packets.

The terminal communication analysis includes at least one of the following data: a communication start timestamp, a communication stop timestamp, an uplink data rate, a downlink data rate, or data traffic.

The user data congestion includes at least one of the following data: an application identifier, an IP packet filtering setting, a policy period, an uplink throughput, a downlink throughput, an uplink throughput peak, a downlink throughput peak, a timestamp, or a sampling ratio.

The deviation analysis includes at least one of the following data: a terminal IP address, a timestamp, an application identifier ID, an IP 5-tuple, a location of an application APP, an uplink data volume, a downlink data volume, or duration of an application.

The WLAN performance includes at least one of the following data: a communication start timestamp, a communication stop timestamp, an uplink data rate, a downlink data rate, or data traffic.

The type of the collected data is shown in Table 2 to Table 6.

TABLE 2
(Network data analysis related to observed service experience)

| | |
|---|---|
| QoS flow bit rate | The observed bit rate for UL direction, and the |
| QoS flow Bit Rate | observed bit rate for DL direction |
| | The observed bit rate for UL direction, and the |
| | observed bit rate for DL direction |
| QoS flow | The observed packet delay for UL direction, and |
| packet delay | the observed packet delay for the DL direction |
| QoS flow | The observed packet delay for UL direction, and |
| Packet Delay | the observed packet delay for the DL direction |
| Packet transmission | The observed number of packet transmission |
| Packet transmission | The observed number of packet transmission |
| Packet retransmission | The observed number of packet retransmission |
| Packet retransmission | The observed number of packet retransmission |

TABLE 3
(Network performance analysis)

| | |
|---|---|
| UE communication | Communication description per application |
| UE communication | Communication description per application |
| Communication start | The timestamp that this communication starts |
| Communication start | The timestamp that this communication starts |
| Communication stop | The timestamp that this communication stops |
| Communication stop | The timestamp that this communication stops |
| Uplink data rate | Uplink rate of this communication |
| UL data rate | UL data rate of this communication |
| Downlink data rate | Downlink rate of this communication |
| DL data rate | DL data rate of this communication |
| Traffic volume | Traffic volume of this communication |
| Traffic volume | Traffic volume of this communication |

TABLE 4
(Network function load analysis)

| | |
|---|---|
| Application ID | Application identifier as defined in TS |
| Application ID | 23.501[2] clause 5.8.2 |
| | Application identifier as defined in TS |
| | 23.501[2] clause 5.8.2 |
| IP packet filter set | IP packet filter set as defined in TS 23 |
| IP Packet Filter Set | IP Packet Filter set as defined in TS |
| | 23.501[2] clause 5.8.2 |
| Measurement period | Measurement period |
| Measurement period | Measurement period |
| Uplink/downlink | Average uplink/downlink throughput |
| throughput | over the measurement period |
| Throughput UL/DL | Average Throughput UL/DL over the |
| | measurement period |
| Uplink/downlink | Peak average uplink/downlink |
| throughput (peak) | throughput over the measurement period |
| Throughput UL/DL | Peak Throughput UL/DL over the |
| (peak) | measurement period |
| Timestamp | Time when measurements are taken |
| Timestamp | Time when measurements are taken |
| Achieved sampling ratio | Sampling ratio achieved by UPF |
| Achieved sampling ratio | Sampling ratio achieved by UPF |

TABLE 5
(Deviation analysis)

| | |
|---|---|
| UE IP address | UE IP address |
| UE IP address | UE IP address |
| Timestamp | A timestamp of the collected information |
| Timestamp | A timestamp of the collected information |
| Application ID | Identify the application at the UPF |
| Application ID | Identify the application at the UPF |
| IP 5-tuple | IP 5-tuple |
| IP 5-tuple | IP 5-tuple |
| Location of | List of Internet applications represented |
| application | by DNAI |
| Location of | List of Internet applications represented |
| Application | by DNAI |
| Uplink/downlink | Sum of UE data volume exchanged per |
| data volume | application during the period |
| Data Volume UL/DL | Sum of UE data volume exchanged per |
| | application during the period |
| Application duration | Duration for the application |
| Application duration | Duration for the application |

TABLE 6
(WLAN performance analysis)

| | |
|---|---|
| UE communication | List of communication time slots |
| UE communication | List of communication time slots |
| Communication start | The timestamp that PDU session (s) |
| Communication start | for WLAN starts |
| | The timestamp that PDU session (s) |
| | for WLAN starts |
| Communication stop | The timestamp that PDU session (s) |
| Communication stop | for WLAN ends |
| | The timestamp that PDU session (s) |
| | for WLAN ends |
| Uplink data rate | UL data rate of PDU session (s) for WLAN |
| UL data rate | UL data rate of PDU session (s) for WLAN |
| Downlink data rate | DL data rate of PDU session (s) for WLAN |
| DL data rate | DL data rate of PDU session (s) for WLAN |
| Traffic volume | Traffic volume of PDU session (s) for WLAN |
| Traffic volume | Traffic volume of PDU session (s) for WLAN |

In other words, the third communication device can accurately collect data based on the type of the received collected data, so that it is more targeted and more efficient when the third communication device collects data.

In some embodiments, the data collection method further includes:
obtaining, by the first communication device, an analytic identifier; and
performing, by the first communication device, at least one of the following based on the analytic identifier:
determining, by the first communication device, a type of the collected target data based on the analytic identifier;
determining, by the first communication device, an event identifier based on the analytic identifier, and determining a type of the collected target data based on the event identifier; or
obtaining, by the first communication device, an event identifier, and determining a type of the collected target data based on event identifier.

In some embodiments, the first communication device may determine the type of the collected target data by using the obtained analytic identifier (Analytic ID). For example, the first communication device may determine several data sub-types that need to be collected in Table 6 by using Analytic ID=WLAN performance, for example, an uplink data rate; or the first communication device may determine an event identifier based on the analytic identifier, and then determine the type of the collected target data based on the event identifier, or determine the type of the collected target data based on the event identifier. For example, the first communication device may determine, by using Analytic ID=WLAN performance, several data sub-types that need to be collected in Table 6, for example, an uplink data rate, and collection of these data sub-types is corresponding to one event ID. For example, data collection for an uplink data rate is corresponding to one event ID, and data collection for a downlink data rate is also corresponding to one event ID. In this way, the NWDAF may obtain a plurality of event IDs through decomposition based on data collection of Analytic ID=WLAN performance, and these event IDs are each corresponding to collection of data of one sub-type.

For example, as shown in Table 7, the first communication device may obtain or disassemble to obtain, based on the analytic identifier, a plurality of event identifiers, and each event identifier is corresponding to collection of one data type. The type of the collected target data is determined based on the event identifier. If the event identifier obtained by the first communication device is an event identifier 1, that is, Event ID 1, it may be determined that the type of the collected target data is a flow bit rate. Further, after receiving the event identifier, the third communication device UPF may collect the target data based on a type corresponding to the event identifier. In some embodiments, each event ID is corresponding to collection of a series of data types, as shown in Table 8.

TABLE 7

| | |
|---|---|
| Event identifier 1 (ID 1) | Flow bit rate (QoS flow Bit Rate) |
| Event identifier 2 (ID 2) | Flow packet delay (QoS flow Packet Delay) |
| Event identifier 3 (ID 3) | Packet transmission |
| Event identifier 4 (ID 4) | Packet retransmission |

For example, as shown in the following Table 8, each Event ID is corresponding to a group of data.

TABLE 8

| Event identifier 1 (ID 1) | Service experience |
|---|---|
| | Flow bit rate (QoS flow Bit Rate) |
| | Flow packet delay (QoS flow Packet Delay) |
| | Packet transmission |
| | Packet retransmission |

After receiving the Event ID, the UPF can directly collect data based on a type of to-be-collected data corresponding to the ID. A type of to-be-collected data corresponding to each event ID is pre-configured. In some embodiments, the first communication device may determine the type of the collected target data based on the analytic identifier. If the analytic identifier obtained by the first communication device is an analytic identifier 1, where the analytic identifier 1 is corresponding to this data type: network data analysis related to observed service experience, the type of the target data that needs to be collected by the first communication device is shown in Table 9, that is, a flow bit rate, a flow packet delay, packet transmission, and packet retransmission need to be collected. In some embodiments, the first communication device may also determine an event identifier based on the analytic identifier, and then determine the type of the collected target data based on the event identifier.

TABLE 9

| Analytic identifier | Type of target data |
|---|---|
| Analytic identifier 1 | Flow bit rate (QoS flow Bit Rate) |
| | Flow packet delay (QoS flow Packet Delay) |
| | Packet transmission |
| | Packet retransmission |

In some embodiments, the analytic identifier may be corresponding to one or more event identifiers, and each analytic identifier includes one or more event identifiers. In other words, the event identifier is first determined based on the analytic identifier, so that a type of data collection is determined based on the event identifier.

The UPF may also have such a capability: The UPF automatically disassembles an analytic identifier sent by the NWDAF into data collection types corresponding to a plurality of event IDs, as described in Table 9. In some embodiments, the UPF directly collects a plurality of data types based on an event ID sent by the NWDAF, as described in Table 7. In some embodiments, the UPF may collect, based on a designed event ID, various data that needs to be collected under the event ID, as described in Table 8.

In the foregoing embodiment, if the first communication device obtains an analytic identifier B from a network function A, the first communication device may determine collected data of a target type based on the analytic identifier B; or the first communication device may determine an event identifier C based on the analytic identifier B, and then determine the type of the collected target data based on the event identifier C; or the first communication device determines collected data of a target type based on an obtained event identifier D (the event identifier D may be to-be-collected data determined by the NWDAF based on the analytic identifier, where the to-be-collected data is included in the event identifier D). In other words, the first communication device may determine the type of the collected target data based on the analytic identifier and/or the event identifier in a plurality of manners, that is, the first communication device may determine the type of the collected target data based on different cases in different manners, which is highly flexible, highly practical, and easy to operate.

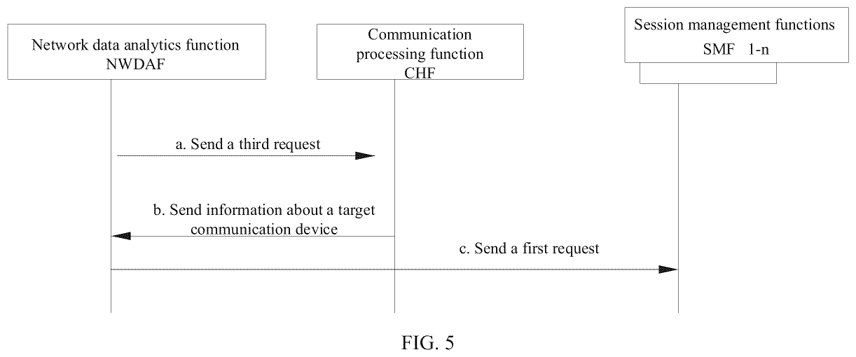

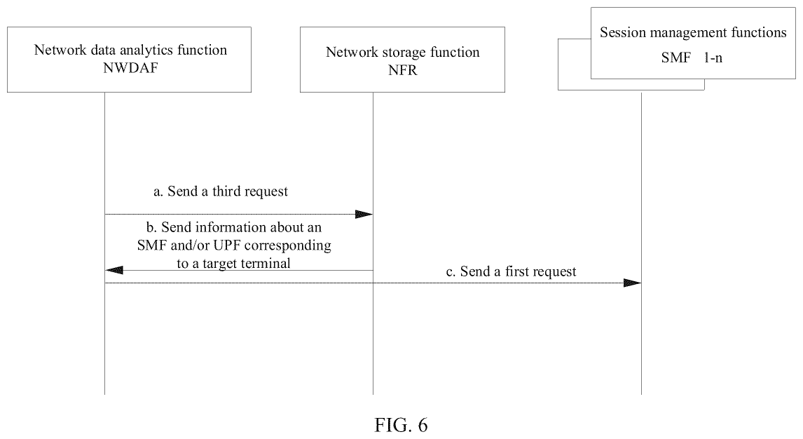

As shown in FIG. 5 and FIG. 6, in a case that there are a plurality of target terminals, before the first communication device sends the first request to the second communication device, the method further includes:
sending, by the first communication device, a third request to a fourth communication device, where the third request is used to request to obtain information about target communication devices corresponding to the plurality of target terminals, where the target communication devices include the second communication device and/or the third communication device.

In some embodiments, in a case that there are the plurality of target terminals, to accurately determine the information about the target communication devices corresponding to the target terminals, the first communication device may send the third request to the fourth communication device to request to obtain the information about the target communication devices. The target communication devices include the second communication device and/or the third communication device. In some embodiments, in a case that the fourth communication device is a CHF, because the CHF has a charging function, where the charging function means that traffic for accessing a DNN or application server IP address can be charged, the CIF may perform filtering when information such as a data network name DNN is sent to the CHF, that is, the CIF uses the DNN, the application server IP address, or the like as a filtering rule to find and send, to the first communication device NWDAF, information about a UPF and/or an SMF corresponding to traffic for accessing the DNN or the application server IP address. In this way, the first communication device NWDAF can collect the target data. The UPF and/or SMF corresponding to the traffic means that a flow for accessing the DNN or the application server IP address is carried by a specific PDU session or a specific QoS flow, and the PDU session or the QoS flow is carried by the UPF or is established between the UE and the UPF. Meanwhile, the PDU session or the QoS flow is carried by the UPF, the UPF is controlled by the SMF, and there is an N4 session between the UPF and the SMF.

In some embodiments, the third request includes at least one of the following information: terminal location information, a data network name DNN, single network slice selection assistance information S-NSSAI, a data network access identifier DNAI, an application server IP address, or a network function type.

In some embodiments, the third request includes at least one of the following information: terminal location information, a data network name DNN, single network slice selection assistance information S-NSSAI, a data network access identifier DNAI, an application server IP address, or a network function type. The fourth communication device may accurately determine the information about the target communication devices based on the third request.

In a case that there are the plurality of target terminals, after the first communication device sends the third request to the fourth communication device, the fourth communication device can accurately determine the information about the plurality of target communication devices based on the information in the third request. Further, after obtaining the target communication device determined by the fourth communication device based on the third request, the first communication device may interact with the target communication device to obtain the target data. For a specific process, reference may be made to the foregoing embodiments. Details are not described herein again.

According to the method in the foregoing embodiment, in a case that there are the plurality of target terminals, the first communication device sends the third request to the fourth communication device, and the fourth communication device may determine information about the target device based on the third request. Therefore, the first communication device can quickly and accurately obtain information about all target communication devices, thereby improving efficiency of obtaining the information about the target communication device by the first communication device.

In some embodiments, the information about the second communication device includes at least one of the following:
an IP address, an instance identifier, or a fully qualified domain name FQDN.

In other words, after obtaining the information about the second communication device, the first communication device may send the first request to the target communication device, that is, the second communication device, based on the obtained information about the second communication device, to obtain the target data collected by the third communication device corresponding to the target terminal.

In some embodiments, before the first communication device sends the third request to the fourth communication device, the method further includes:
obtaining, by the first communication device based on an application server IP address corresponding to the target terminal, at least one of the following information corresponding to the application server IP address: a data network name DNN, single network slice selection assistance information S-NSSAI, or a data network access identifier DNAI.

If target data corresponding to a terminal is to be collected, but there is no information such as a DNN, S-NSSAI, or a DNAI, the NWDAF may first obtain, by using an application server IP address, information such as a DNN, S-NSSAI, or a DNAI corresponding to the IP address. In other words, when the first communication device obtains only the application server IP address corresponding to the target terminal, the first communication device may further obtain at least one of the following information based on the application server IP address: a data network name DNN, single network slice selection assistance information S-NSSAI, or a data network access identifier DNAI. In other words, the first communication device may determine, based on the application server IP address corresponding to the target terminal, more detailed network information corresponding to the target terminal. Therefore, the fourth communication device can accurately determine the information about the target communication device based on the more detailed information determined by the first communication device.

In some embodiments, in a case that the target communication device includes the second communication device, that the first communication device sends the first request to the second communication device includes:
the first communication device separately sends the first request to a plurality of second communication devices.

In other words, in a case that there are a plurality of target terminals, the target terminals correspond to a plurality of second communication devices. The first communication device sends the first request to the plurality of second communication devices and may further obtain, based on the first request, target data collected by a plurality of third communication devices corresponding to a plurality of target terminals controlled by each second communication device, and each second communication device may determine information about a third communication device corresponding to a served target terminal, to request the third communication device corresponding to the target terminal to collect the target data. For a specific process, reference may be made to the foregoing embodiments. Details are not described herein again.

In some embodiments, the collected target data is data that is sent by a plurality of target terminals to target nodes and that is collected by the third communication device.

In some embodiments, when the plurality of target terminals send data to a same node, data may be collected based on the target nodes, thereby improving efficiency of data collection.

For example, when the data sent by the plurality of target terminals to a target node A needs to be collected, the data of the plurality of target terminals may be separately collected, and then data to be sent to the target node A is selected from all the data and summarized, to obtain finally required data. In some embodiments, data may be collected directly based on information about the target node by using the method in this embodiment. In the method in this embodiment, data is collected directly based on the information about the target node, so that data corresponding to the target node may be obtained at one time, and efficiency is high.

According to the method in the foregoing embodiment, when data sent by the plurality of target terminals to a same target node needs to be collected, the target data may be collected based on the target node, that is, all data corresponding to the target node may be obtained at one time based on the node. Therefore, efficiency is high.

In some embodiments, the target nodes are a same node, and the target nodes include at least one of the following:
nodes corresponding to a same destination server IP address or nodes corresponding to a same data network DN.

In some embodiments, when data flows of the plurality of target terminals have a same destination service IP address, that is, nodes corresponding to the same destination server IP address are the target nodes, or when data flows of the plurality of target terminals have a same data network DN, that is, nodes corresponding to the same data network DN are the target nodes, data may be collected based on the target nodes. For example, the second communication device SMF determines, based on information such as a terminal identifier, a data network name DNN, a packet data unit PDU session identifier, single network slice selection assistance information S-NSSAI, an application identifier, an analytic identifier, an event identifier, a type of the target data, and a data network access identifier DNAI that are sent by the first communication device NWDAF, the third communication device UPF corresponding to the target terminal, and may further determine information such as a PDU session identifier or a quality of service QoS flow identifier QFI that is carried by the UPF and that is sent by the target terminal to an application server address. Then, the second communication device SMF determines a packet detection rule PDR based on the foregoing information, and sends the packet detection rule PDR to the third communication device UPF. After the third communication device UPF detects, by using the packet detection rule PDR, traffic that is to be sent to a destination server IP address included in the PDR, the UPF may collect related information, such as quality of service related information, corresponding to the traffic.

In other words, the third communication device uses the destination server IP address, the data network DN, or the PDR to select data sent by the plurality of target terminals to the target nodes, so that the target data can be collected based on the target nodes, and efficiency of data collection can be effectively improved. In this method, data of a plurality of PDU sessions or QoS flows accessing a same target node may be collected.

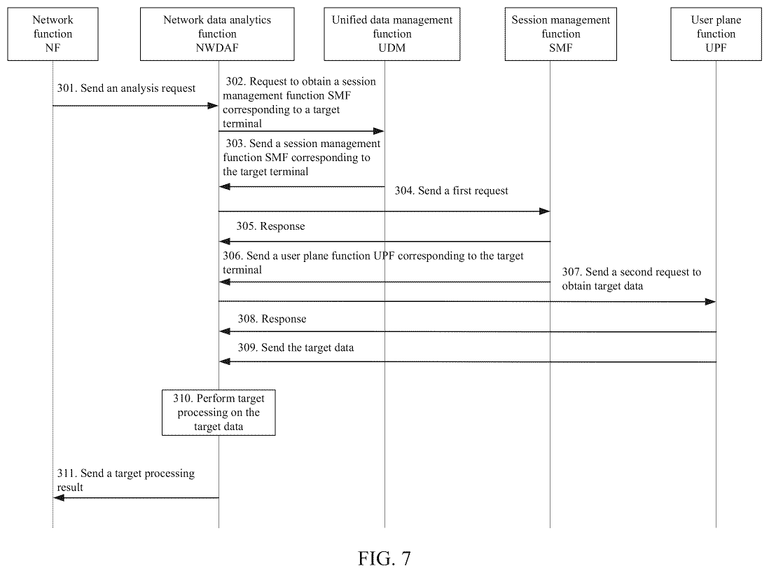

FIG. 7 is a schematic diagram of an interaction procedure of a data collection method according to an embodiment of this application. For a direct data collection process of a single terminal, the data collection method provided in this embodiment includes the following steps:

Step 301: Send an analytics request.

When a network function (NF) needs to obtain a data analysis or prediction result from an NWDAF, for example, when the network function needs to obtain an analysis result of network data analysis related to observed service experience from the NWDAF, the network function sends an analytics request to the NWDAF. In some embodiments, the following request may be sent to the NWDAF:
an analytics information request (Nwdaf_AnalyticsInfo_Request) or analysis subscription (Nwdaf_AnalyticsSubscription_Subscribe), where Analytics ID=Service Experience (or may be another Analytic ID), Target of Analytics Reporting=single UE (SUPI), Analytics Filter Information=(Application ID, S-NSSAI, DNN, Application Server Address, Area of Interest), and Analytics Reporting Information=Analytics target period).

Step 302: Request to obtain a second communication device SMF corresponding to a target terminal.

In some embodiments, the first communication device NWDAF may send a request (for example, signaling Nudm_UECM_Get) to a unified data management function UDM to request to obtain the second communication device SMF corresponding to the target terminal. Input parameters are as follows: a terminal identifier and a network function type NF type=SMF.

A purpose is to find an SMF IP address or an SMF instance ID that serves the target terminal from the UDM.

Step 303: The unified data management function UDM sends, to the first communication device NWDAF, the second communication device SMF corresponding to the target terminal.

In some embodiments, when the unified data management function UDM finds a session management function SMF that serves the current terminal, the data unified management function sends an identifier and an IP address of the session management function SMF to the first communication device.

Step 304: The first communication device NWDAF sends a first request to the second communication device SMF.

After the first communication device NWDAF finds an SMF that serves the target terminal, the first communication device sends the first request to the second communication device to find a third communication device that serves the target terminal. In some embodiments, a manner of sending the first request may be a subscription manner, or may be a get manner. To be specific, the first communication device NWDAF directly obtains, from the SMF, information about the third communication device UPF corresponding to the target terminal, and the SMF directly provides the information about the UPF. In some embodiments, the first communication device NWDAF sends the following signaling to the second communication device SMF: SMF event exposure subscription Nsmf_EventExposure_Subscribe, or another signaling may be sent. A parameter includes at least one of the following:
a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, or a quality of service QoS flow identifier QFI, where the analytic identifier and the event identifier are used to indicate the type of the collected target data, and the analytic identifier corresponds to at least one event identifier.

In some embodiments, the session management function SMF may provide content related to the UPF or a PDU session, for example, including at least one of the following:
user plane status information, such as an event notification;
a PDU session identifier;
a user plane inactivity timer; or
a PDU session status.

Step 305: Make a response.

In a case that the first communication device sends the first request in a subscription manner, when the second communication device receives the first request, the second communication device makes a response to the subscription.

Step 306: The second communication device SMF sends, to the first communication device NWDAF, information about the third communication device UPF corresponding to the target terminal.

In some embodiments, the SMF sends, to the first communication device NWDAF, the information about the third communication device UPF corresponding to the target terminal, where the following parameters are included: an IP address of the third communication device, an identifier of the third communication device, a fully qualified domain name FQDN, a PDU session identifier PDU session ID, a packet detection rule PDR, and a quality of service QoS flow identifier QFI. In other words, information such as the IP address of the third communication device UPF corresponding to the target terminal and information such as an identifier of a PDU session from the current terminal to an application server.

Step 307: The first communication device NWDAF sends a second request to obtain target data.

For example, the second request may be Nupf_EventExposure_Subscribe.

In some embodiments, after obtaining the information about the third communication device UPF, the first communication device sends the second request to collect and/or obtain the target data from the UPF.

In some embodiments, when the first communication device NWDAF collects the target data from the third communication device UPF, the first communication device NWDAF determines, based on the analytic identifier Analytic ID, information to be collected from the third communication device UPF, and the first communication device NWDAF triggers subscription or acquisition to the third communication device UPF. For example, an event identifier may be designed to indicate a service that can be exposed by the UPF: Nupf_EventExposure_Subscribe (event ID, PDU session ID, SUPI, DNN, S-NSSAI, and the like). For example, one analytic identifier may correspond to one or more event identifiers. In some embodiments, there are two manners. In one manner, a data type is determined by using the event identifier, for example, event ID=QoS flow Bit Rate, and the NWDAF provides event identifiers event IDs corresponding to all data that needs to be collected for the UPF. In a second manner, each event identifier event ID corresponds to data collection of a group of data types, and after receiving the event identifier event ID, the third communication device UPF can directly collect the target data based on a data collection type corresponding to the event identifier. In some embodiments, the first communication device NWDAF further needs to send a packet detection rule PDR and a quality of service QoS flow identifier QFI that need to be collected, and the UPF identifies traffic that is sent by the target terminal to an IP address of the server, and then counts and reports the traffic.

Step 308: Make a response.

In a case that the first communication device sends the second request in a subscription manner, when the third communication device receives the second request, the third communication device makes a response to the subscription.

Step 309: Send the target data, that is, after collecting the data, the UPF sends the target data to the first communication device NWDAF.

In some embodiments, the third communication device sends signaling (for example, notification signaling Nupf_EventExposure_Notify), and sends information collected by the UPF to the NWDAF. Data included in the signaling is to-be-collected data corresponding to the event identifier event ID, for example, a flow bit rate is QoS flow Bit Rate. In some embodiments, the event identifier event ID corresponds to a group of collected data, for example, collected data formed by a plurality of event IDs corresponding to analytic ID=WLAN performance, for example, an uplink data rate or a downlink data rate.

Step 310: The first communication device performs target processing on the target data.

In other words, after collecting the data from the UPF, the first communication device NWDAF performs target processing on the target data to obtain a target processing result.

Step 311: Send the target processing result.

In other words, the first communication device NWDAF sends an analysis result to a network function, that is, sends the analysis result to a user.

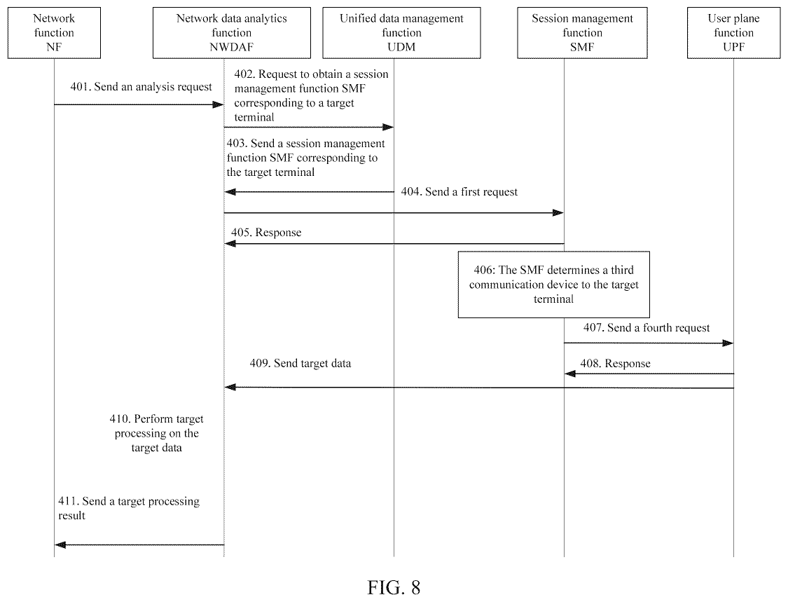

FIG. 8 is a schematic diagram of an interaction procedure of a data collection method according to an embodiment of this application. This procedure is indirect data collection of a single terminal, and is as follows:

Step 401: A network function sends an analytics request to a first communication device NWDAF.

Step 402: The first communication device NWDAF requests to obtain a second communication device SMF corresponding to a target terminal.

Step 403: A unified data management function UDM sends, to the first communication device NWDAF, the second communication device SMF corresponding to the target terminal.

Step 404: The first communication device NWDAF sends a first request to the second communication device SMF device, where the first request is used to request to obtain target data collected by a third communication device corresponding to the target terminal.

Step 405: Make a response.

In a case that the first communication device sends the first request in a subscription manner, when the second communication device receives the first request, the second communication device makes a response to the subscription.

Step 406: The SMF determines the third communication device corresponding to the target terminal.

The second communication device SMF determines, based on the first request sent by the NWDAF, the third communication device corresponding to the target terminal, for example, determines a UPF that carries a PDU session established by the target terminal to an application server. Data collection can be started only after the third communication device corresponding to the target terminal is determined.

In some embodiments, the second communication device SMF determines, based on information such as a terminal identifier, a data network name DNN, a packet data unit PDU session identifier, single network slice selection assistance information S-NSSAI, an application identifier, an analytic identifier, an event identifier, a type of the target data, and a data network access identifier DNAI that are sent by the first communication device NWDAF, the third communication device UPF corresponding to the target terminal, and may further determine information such as a PDU session identifier or a quality of service QoS flow identifier QFI that is carried by the UPF and that is sent by the target terminal to an application server address. Then, the second communication device SMF determines a packet detection rule PDR based on the foregoing information, and sends the packet detection rule PDR to the third communication device UPF. After the third communication device UPF detects, by using the packet detection rule PDR, traffic that is to be sent to a destination server IP address, the UPF may consider that there is the traffic, and can collect related information, such as quality of service related information, corresponding to the traffic.

Step 407: Send a fourth request.

The second communication device SMF sends the fourth request to trigger a data collection request to the third communication device UPF. In some embodiments, subscription signaling (Nupf_EventExposure_Subscribe (for example, including event ID, PDU session ID, SUPI, DNN, S-NSSAI, NWDAF IP address, QFI, PDR, and the like)) is sent. In some embodiments, an IP address of the NWDAF needs to be provided in this message. In some embodiments, after collecting the data, the UPF may directly send the target data to the NWDAF. Therefore, a network function to which the collected data is to be sent needs to be indicated to the UPF. In some embodiments, the SMF sends the determined packet detection rule PDR, the determined quality of service QoS flow identifier QFI, the determined PDU session, and the like to the UPF, to identify and count traffic.

Step 408: Make a response.

In a case that the second communication device sends the fourth request in a subscription manner, when the third communication device receives the fourth request, the third communication device makes a response to the subscription.

Step 409: Send the target data, that is, after collecting the data, the UPF sends the target data to the first communication device NWDAF.

The third communication device sends signaling (for example, notification signaling Nupf_EventExposure_Notify), and directly sends information collected by the UPF to the NWDAF. Data included in the signaling is to-be-collected data corresponding to the event identifier event ID, for example, a flow bit rate is QoS flow Bit Rate.

In some embodiments, the UPF may send the collected data to the SMF. For example, the UPF sends the collected data to the SMF by using the notification signaling Nupf_EventExposure_Notify; and then, the SMF sends the collected data to the NWDAF, for example, forwards the collected data by using the notification signaling Nsmf_EventExposure_Notify.

Step 410: The first communication device performs target processing on the target data.

In other words, after collecting the data from the UPF, the first communication device NWDAF performs target processing on the target data to obtain a target processing result.

Step 411: Send the target processing result.

In other words, the first communication device NWDAF sends an analysis result to a network function, that is, analyzes the analysis result to a user.

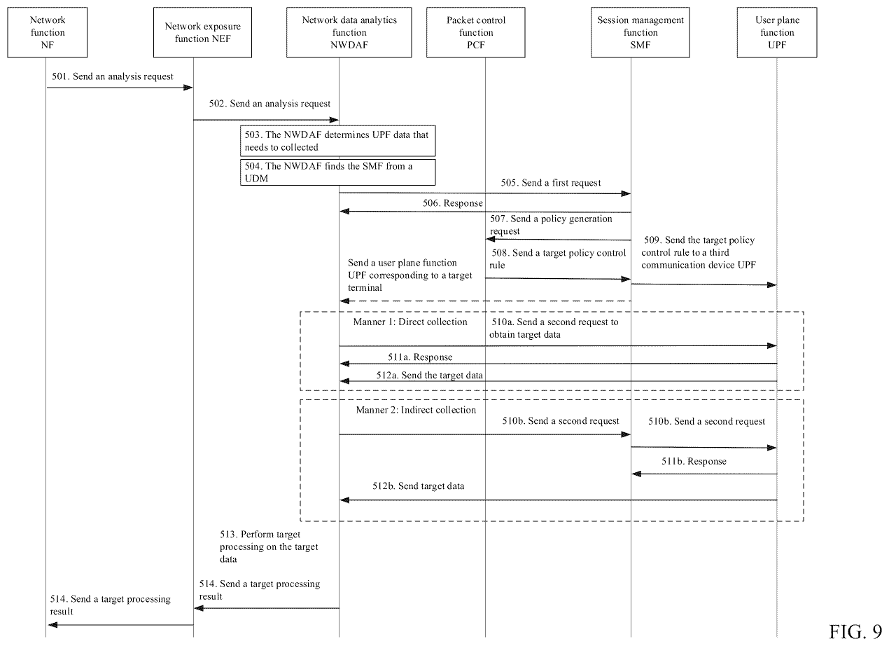

FIG. 9 is a schematic diagram of an interaction procedure of a data collection method according to an embodiment of this application. The interaction procedure is as follows:

For steps 501 to 506, reference may be made to steps in the schematic diagram of the interaction procedure. A first communication device sends a first request to a second communication device.

Step 507: The second communication device sends a policy generation request to a fifth communication device.

After the second communication device SMF receives the first request sent by the first communication device NWDAF, the second communication device may trigger a policy generation request to a PCF. In some embodiments, signaling may be sent, such as session management policy control request signaling (Npcf_SMPolicyControl_Create_request) or session management policy control update request signaling (Npcf_SMPolicyControl_Update request). For example, at least one of the following parameters is included: a terminal identifier, a packet data unit PDU session identifier, a data network name DNN, single network slice selection assistance information S-NSSAI, an analytic identifier, an event identifier, or a terminal IP address.

Step 508: The fifth communication device PCF sends a target policy control rule to the second communication device.

Step 509: The second communication device sends the target policy control rule to a third communication device UPF.

In some embodiments, the SMF configures a new Policy and Charging Control (PCC) rule for the UPF by using an N4 session process or another process, that is, the UPF collects corresponding data by using the PCC rule.

Steps 510 to 514: The first communication device directly or indirectly collects or obtains target data. For details, reference may be made to the embodiment of the data collection method.

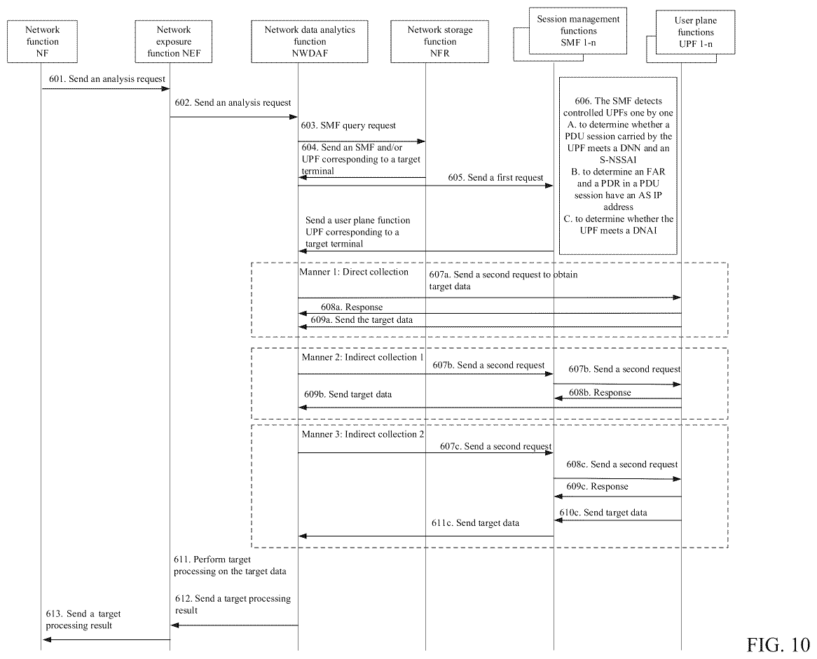

FIG. 10 is a schematic diagram of an interaction procedure of a data collection method according to an embodiment of this application. The interaction procedure is as follows:

In a case that target data corresponding to a plurality of terminals needs to be collected, for example, all terminals connected to a third-party server, instead of a third communication device UPF corresponding to a single target terminal, UPFs corresponding to a plurality of target terminals are searched for.

Steps 601 and 602: A first communication device receives an analytics request, where the analytics request is used to request the analysis of target data corresponding to a plurality of target terminals.

Step 603: The first communication device sends a third request to a fourth communication device, that is, sends an SMF query request.

When the first communication device NWDAF needs to collect the target data corresponding to the plurality of target terminals, the first communication device needs to first find SMFs corresponding to the plurality of target terminals. Information such as S-NSSAI, a DNN, and a DNAI is provided. Therefore, in some embodiments, the NWDAF triggers the SMF query request to an NRF. For example, the SMF query request is carried by using network function discovery request signaling (Nnrf_NFDiscovery_Request). The third request includes at least one of the following information: terminal location information, a data network name DNN, single network slice selection assistance information S-NSSAI, a data network access identifier DNAI, an application server IP address, or a network function type. The query request is used to find a plurality of SMFs.

Step 604: The NRF sends the SMFs corresponding to the target terminals to the first communication device.

The NRF determines, based on the third request sent by the first communication device, the plurality of SMFs corresponding to the target terminals, and sends information such as IP addresses and SMF identifiers of the plurality of SMFs to the NWDAF. The SMFs are SMFs corresponding to terminals that meet a condition (for example, accessing a same server IP address or DN) and that are to collect data. In other words, the SMFs provide session management for these terminals.

Steps 605 to 613: The first communication device directly or indirectly collects or obtains target data. For details, reference may be made to the embodiment of the data collection method. In some embodiments, the NWDAF sends a UPF data collection request to each SMF, and then the SMF finds a UPF that meets a requirement. In addition, after determining the UPF based on a DNN, S-NSSAI, a DNAI, an APP ID, a UE IP, a UE SUPI, an application server IP address, and the like that are sent by the NWDAF, each SMF further needs to determine a PDU session identifier and a quality of service QoS flow identifier QFI that are carried by the UPF and that are sent by the target terminals to the application server address. Then, each SMF determines a packet detection rule PDR based on the foregoing information, and sends the packet detection rule PDR to the UPF. After the UPF detects, by using the packet detection rule PDR, traffic that is to be sent to a destination server IP address included in the PDR, the UPF may collect quality of service related information corresponding to the traffic. In addition, because target data of the plurality of target terminals is collected, the SMF may need to send a data collection request to a plurality of UPFs, and one UPF may carry PDU sessions that are of the plurality of target terminals and that are connected to the application server IP address. Therefore, in this case, the UPF may consider node-based data collection. For example, the SMF first finds a UPF that meets a requirement, analyzes whether a PDU session carried by the UPF is corresponding to a DNN and S-NSSAI, and analyzes whether an FAR and a PDR in the PDU session carried by the UPF have an application server AS IP address, and if yes, it indicates that traffic to the application server is carried; the SMF analyzes whether the UPF meets the DNAI; and then, the SMF triggers the UPF to collect data. In this case, because the plurality of terminals perform collection, the SMF may indicate the UPF to perform collection based on a node. For example, the UPF can count data related to quality of service of all uplink traffic to the application server address. In this case, data is collected based on a node instead of each terminal. For example, same destination IP addresses are the same. In this case, target data of the plurality of terminals may be collected and counted based on a node; in other words, data of the same destination IP address is collected.

After the plurality of SMFs are determined, the multiple plurality of SMFs determine UPFs. These UPFs are terminals that meet a condition (for example, accessing a same server IP address or DN) and that are to collect data. Corresponding UPFs carry sessions (for example, to a server IP address or DN) of the terminals, or the UPFs establish PDU sessions with the terminals that meet the condition. The PDU session is for accessing a server IP address or DN.

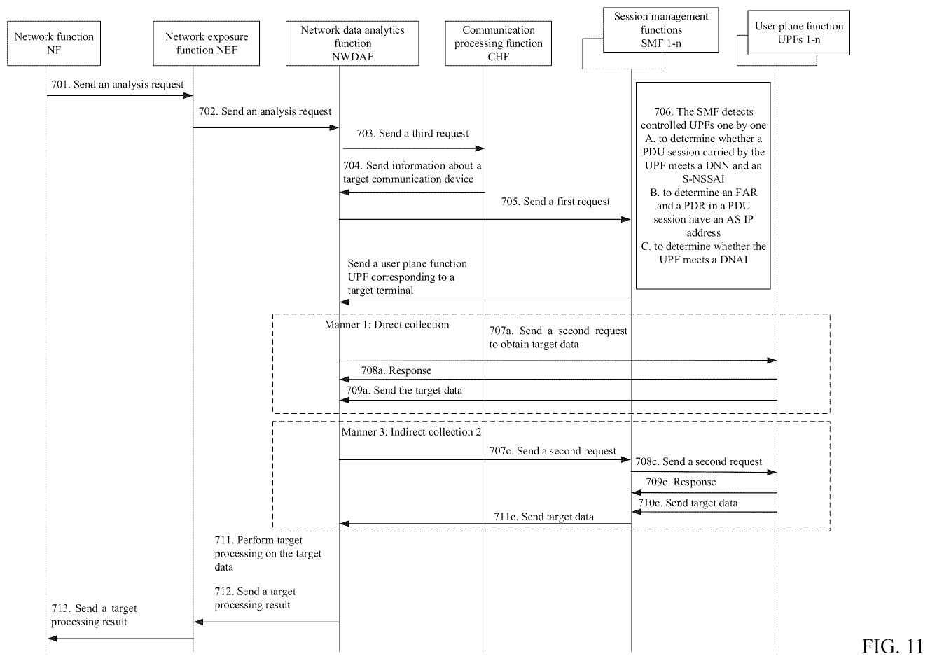

FIG. 11 is a schematic diagram of an interaction procedure of a data collection method according to an embodiment of this application. The interaction procedure is as follows:

Steps 701 and 702: A first communication device receives an analytics request, where the analytics request analyzes target data corresponding to a plurality of target terminals.

Step 703: The first communication device sends a third request to a fourth communication device CHF, that is, sends an SMF and/or UPF query request.

The first communication device NWDAF sends the third request to the fourth communication device CHF, where the third request includes at least one of the following information: terminal location information, a data network name DNN, single network slice selection assistance information S-NSSAI, a data network access identifier DNAI, an application server IP address, or a network function type, to trigger a query request. For example, a call bill query request is carried in Charging Data Request signaling to find all call bill information that is corresponding to a DNN, S-NSSAI, and Application server IP and that meets a UE location. Charging information corresponding to these terminals after accessing a DN or a server IP address and a UPF and an SMF that generate charging or traffic counting are described in detail in each piece of call bill information. Based on the foregoing process, a corresponding UPF and an SMF that generates the charging or traffic counting are found. The CIF feeds back a UPF IP address and an SMF IP address to the first communication device.

Step 704: The fourth communication device CIF sends, to the first communication device NWDAF, an SMF and/or a UPF corresponding to the target terminal.

The CIF feeds back all SMF IP addresses, SMF instance IDs, UPF IP addresses, and UPF instance IDs that meet a condition to the NWDAF. When the fourth communication device sends a UPF corresponding to the target terminal to the NWDAF, steps 5 to 7 may be omitted.

Steps 705 to 713: The first communication device directly or indirectly collects and/or obtains the target data. For details, reference may be made to the embodiment of the data collection method.

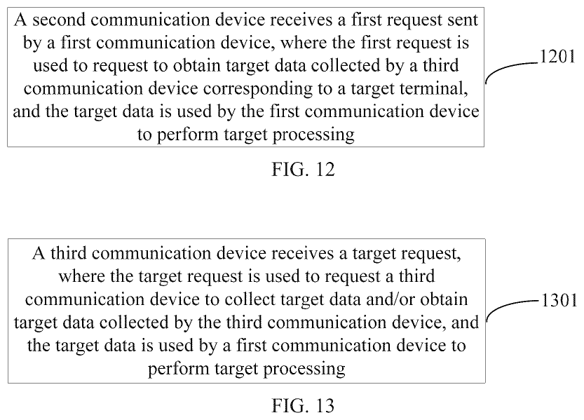

FIG. 12 is a second schematic flowchart of a data collection method according to an embodiment of this application. As shown in FIG. 12, the method provided in this embodiment includes the following steps:

Step 1201: A second communication device receives a first request sent by a first communication device, where the first request is used to request to obtain target data collected by a third communication device corresponding to a target terminal, and the target data is used by the first communication device to perform target processing.

In some embodiments, the method further includes:
determining, by the second communication device based on the first request, information about the third communication device corresponding to the target terminal; and
sending, by the second communication device, a fourth request to the third communication device based on the information about the third communication device, where the fourth request is used to request the third communication device to collect the target data and/or obtain the target data collected by the third communication device; or
sending, by the second communication device, the information about the third communication device to the communication device.

In some embodiments, the method further includes:
receiving, by the second communication device, the target sent by third communication device, and forwarding the target data to the first communication device.

In some embodiments, the fourth request includes at least one of the following:
a data network name DNN, a PDU session identifier, single network slice selection assistance information S-NSSAI, an application server IP address, an analytic identifier, an event identifier, a QoS flow identifier QFI, an identifier of the target terminal, an IP address of the target terminal, or an IP address of the first communication device, where the analytic identifier and the event identifier are used to indicate a type of the collected target data, and analytic identifier corresponds to at least one event identifier.

In some embodiments, the method further includes:
determining, by the second communication device based on the first request, information about the third communication device corresponding to the target terminal; and
sending, by the second communication device, a policy generation request to a fifth communication device based on the information about the third communication device, where the policy generation request is used to request the fifth communication device to generate a target policy control rule corresponding to the third communication device, and the target policy control rule is to indicate a type of collected data; and
sending, by the second communication device, the target policy control rule to the third communication device.

In some embodiments, the method further includes:
determining, by the second communication device based the first request, that third communication device carries session information of the target terminal, where the session information includes at least one of the following: a packet detection rule PDR, a PDU session identifier, or a quality of service QoS flow identifier QFI; and
sending, by the second communication device, the session information to the third communication device, where session information is used by the third communication device to collect the target data.

In some embodiments, the first request includes at least one of the following:
a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, or a quality of service QoS flow identifier QFI, where the analytic identifier and the event identifier are used to indicate the type of the collected target data, and the analytic identifier corresponds to at least one event identifier.

In some embodiments, the collected target data is data that is sent by a plurality of target terminals to target nodes and that is collected by the third communication device.

In some embodiments, the target nodes are a same node, and the target nodes include at least one of the following:
nodes corresponding to a same destination server IP address or nodes corresponding to a same data network DN.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, or data network performance analysis.

A specific implementation process and technical effects of the method in this embodiment are similar to those of the method embodiment on the first communication device side. For details, reference may be made to the detailed description in the method embodiment on the first communication device side. Details are not described herein again.

FIG. 13 is a third schematic flowchart of a data collection method according to an embodiment of this application; As shown in FIG. 13, the method provided in this embodiment includes the following steps:

Step 1301: A third communication device receives a target request, where the target request is used to request a third communication device to collect target data and/or obtain target data collected by the third communication device, and the target data is used by a first communication device to perform target processing.

In some embodiments, the target request includes a first request sent by the first communication device, a second request sent by the first communication device, or a fourth request sent by a second communication device.

In some embodiments, the method further includes:
in a case that the target request is used to request the third communication device to collect the target data, collecting, by the third communication device, the target data based on target request; or
in a case that the target request is used to request to obtain the target data collected by the third communication device, sending, by the third communication device, the collected target data to the first communication device or the second communication device based on the target request.

In some embodiments, the second request includes at least one of the following:
a terminal identifier, a data network name DNN, a packet data unit PDU session identifier, single network slice selection assistance information S-NSSAI, an application server IP address, an application identifier, an analytic identifier, an event identifier, a type of the target data, a data network access identifier DNAI, a packet detection rule PDR, or a quality of service QoS flow identifier QFI, where the analytic identifier and the event identifier are used to indicate the type of the target data, and the analytic identifier corresponds to at least one event identifier.

In some embodiments, the fourth request includes at least one of the following:
a data network name DNN, a PDU session identifier, single network slice selection assistance information S-NSSAI, an application server IP address, an analytic identifier, an event identifier, a QoS flow identifier QFI, an identifier of the target terminal, an IP address of the target terminal, or an IP address of the first communication device, where the analytic identifier and the event identifier are used to indicate a type of the collected target data, and analytic identifier corresponds to at least one event identifier.

In some embodiments, the method further includes:
receiving, by the third communication device, a target policy control rule sent by the second communication device, where the target policy control rule is used to indicate a type of collected data.

In some embodiments, the method further includes:
receiving, by the third communication device, session information sent by second communication device, where the session information includes at least one of the following: a packet detection rule PDR, a PDU session identifier, or a quality of service QoS flow identifier QFI; and
collecting, by the third communication device, the target data based on the session information.

In some embodiments, the third communication device collects, based on the PDR, target data sent by a plurality of target terminals to target nodes.

In some embodiments, the third communication device determines a type of the target data based on an analytic identifier and/or an event identifier. The analytic identifier and the event identifier are used to indicate the type of the target data, and the analytic identifier corresponds to at least one event identifier.

The third communication device collects the target data based on the type of the target data.

In some embodiments, the first request includes at least one of the following:
a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, or a quality of service QoS flow identifier QFI, where the analytic identifier and the event identifier are used to indicate the type of the collected target data, and the analytic identifier corresponds to at least one event identifier.

In some embodiments, the target nodes are a same node, and the target nodes are determined by using at least one of the following information:
nodes corresponding to a same destination server IP address or nodes corresponding to a same data network DN.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, or data network performance analysis.

A specific implementation process and technical effects of the method in this embodiment are similar to those of the method embodiment on the first communication device side. For details, reference may be made to the detailed description in the method embodiment on the first communication device side. Details are not described herein again.

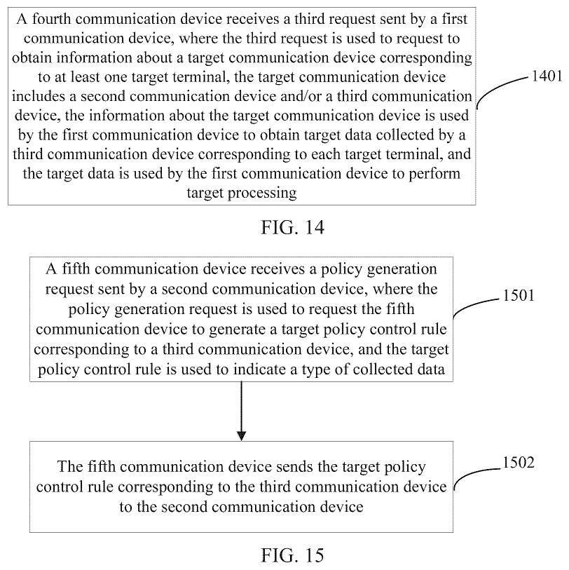

FIG. 14 is a fourth schematic flowchart of a data collection method according to an embodiment of this application. As shown in FIG. 14, the method provided in this embodiment includes the following steps:

Step 1401: A fourth communication device receives a third request sent by a first communication device, where the third request is used to request to obtain information about a target communication device corresponding to at least one target terminal, the target communication device includes a second communication device and/or a third communication device, the information about the target communication device is used by the first communication device to obtain target data collected by a third communication device corresponding to each target terminal, and the target data is used by the first communication device to perform target processing.

In some embodiments, the fourth communication device sends the information about the target communication device to the first communication device.

In some embodiments, the third request includes at least one of the following information: terminal location information, a data network name DNN, single network slice selection assistance information S-NSSAI, a data network access identifier DNAI, an application server IP address, and a network function type.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, and data network performance analysis.

A specific implementation process and technical effects of the method in this embodiment are similar to those of the method embodiment on the first communication device side. For details, reference may be made to the detailed description in the method embodiment on the first communication device side. Details are not described herein again.

FIG. 15 is a fifth schematic flowchart of a data collection method according to an embodiment of this application. As shown in FIG. 15, the method provided in this embodiment includes the following steps:

Step 1501: A fifth communication device receives a policy generation request sent by a second communication device, where the policy generation request is used to request the fifth communication device to generate a target policy control rule corresponding to a third communication device, and the target policy control rule is used to indicate a type of collected data.

Step 1502: The fifth communication device sends the target policy control rule corresponding to the third communication device to the second communication device.

In some embodiments, the policy generation request is sent after the second communication device receives the first request sent by the first communication device, and the first request is used to request to obtain target data collected by a third communication device corresponding to a target terminal. The target data is used by a first communication device to perform target processing.

In some embodiments, the first request includes at least one of the following:
a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, and a quality of service QoS flow identifier QFI, where the analytic identifier and the event identifier are used to indicate the type of the collected target data, and the analytic identifier corresponds to at least one event identifier.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, and data network performance analysis.

A specific implementation process and technical effects of the method in this embodiment are similar to those of the method embodiment on the first communication device side. For details, reference may be made to the detailed description in the method embodiment on the first communication device side. Details are not described herein again.

The data collection method provided in the embodiments of this application may be performed by a data collection apparatus. In the embodiments of this application, a data collection apparatus provided in the embodiments of this application is described by using an example in which the data collection apparatus performs the data collection method.

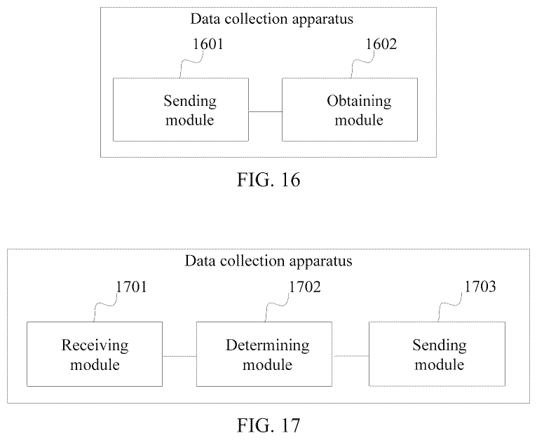

FIG. 16 is a first schematic diagram of a structure of a data collection apparatus according to an embodiment of this application. As shown in FIG. 16, the data collection apparatus provided in this embodiment includes:
a sending module 1601, configured to send a first request to a target communication device, where the first request is used to request to obtain target data collected by a third communication device corresponding to a target terminal, and the target data is used by a first communication device to perform target processing; and
an obtaining module 1602, configured to obtain the target data collected by the third communication device.

In some embodiments, the apparatus further includes a receiving module, configured to: in a case that the target communication device is the second communication device, receive information about the third communication device that is sent by a second communication device.

In some embodiments, the sending module 1601 is configured to send a second request to the third communication device based on the information about the third communication device, where the second request is used to request the third communication device to collect the target data and/or obtain the target data collected by the third communication device.

In some embodiments, in a case that the second request is used to request to obtain the target data collected by the third communication device, the obtaining module 1602 is configured to receive the collected target data sent by the third communication device.

In some embodiments, the receiving module is configured to: receive the collected target data sent by the third communication device; or
receive the target data sent by the second communication device and collected by the third communication device.

In some embodiments, the receiving module is configured to receive the collected target data sent by the third communication device.

In some embodiments, in a case that the target communication device is the third communication device, the first request is further used to request the third communication device to collect the target data.

In some embodiments, the target data is collected by the third communication device based on a target policy control rule, and the target policy control rule is used to indicate a type of the collected data.

In some embodiments, the target policy control rule includes at least one of the following information:
a terminal identifier, an analytic identifier, an event identifier, PDU session information, data collection time information, data collection frequency information, and the type of the collected data.

In some embodiments, the type of the collected data includes at least one of the following: observed service experience, terminal communication analysis, user data congestion, deviation analysis, and wireless WLAN performance.

The observed service experience includes at least one of the following data: a QoS flow bit rate, a QoS flow packet delay, a quantity of transmitted packets, and a quantity of retransmitted packets.

The terminal communication analysis includes at least one of the following data: a communication start timestamp, a communication stop timestamp, an uplink data rate, a downlink data rate, and data traffic.

The user data congestion includes at least one of the following data: an application identifier, an IP packet filtering setting, a policy period, an uplink throughput, a downlink throughput, an uplink throughput peak, a downlink throughput peak, a timestamp, and a sampling ratio.

The deviation analysis includes at least one of the following data: a terminal IP address, a timestamp, an application identifier ID, an IP 5-tuple, a location of an application APP, an uplink data volume, a downlink data volume, and duration of an application.

The WLAN performance includes at least one of the following data: a communication start timestamp, a communication stop timestamp, an uplink data rate, a downlink data rate, and data traffic.

In some embodiments, the first request includes at least one of the following: a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, and a quality of service QoS flow identifier QFI, where the analytic identifier and the event identifier are used to indicate the type of the collected target data, and the analytic identifier corresponds to at least one event identifier.

In some embodiments, the second request includes at least one of the following: a terminal identifier, a data network name DNN, a packet data unit PDU session identifier, single network slice selection assistance information S-NSSAI, an application server IP address, an application identifier, an analytic identifier, an event identifier, a type of the target data, a data network access identifier DNAI, a packet detection rule PDR, and a quality of service QoS flow identifier QFI, where the analytic identifier and the event identifier are used to indicate a type of the collected target data, and the analytic identifier corresponds to at least one event identifier.

In some embodiments, the obtaining module 1602 is further configured to: obtain an analytic identifier, and perform at least one of the following based on the analytic identifier:
determining a type of the collected target data based on the analytic identifier;
determining an event identifier based on the analytic identifier, and determining a type of the collected target data based on the event identifier; or
obtaining an event identifier, and determining a type of the collected target data based on event identifier.

In some embodiments, the sending module 1601 is further configured to send a third request to a fourth communication device. The third request is used to request to obtain information about target communication devices corresponding to a plurality of target terminals, and the target communication devices include the second communication device and/or the third communication device.

In some embodiments, the third request includes at least one of the following information: terminal location information, a data network name DNN, single network slice selection assistance information S-NSSAI, a data network access identifier DNAI, an application server IP address, and a network function type.

In some embodiments, in a case that the target communication devices include the second communication device, the sending module 1601 is configured to separately send the first request to a plurality of second communication devices.

In some embodiments, the collected target data is data that is sent by a plurality of target terminals to target nodes and that is collected by the third communication device.

In some embodiments, the target nodes are a same node, and the target nodes include at least one of the following:
nodes corresponding to a same destination server IP address and nodes corresponding to a same data network DN.

In some embodiments, before the first communication device sends the third request to the fourth communication device, the obtaining module 1602 is further configured to obtain, based on an application server IP address corresponding to the target terminal, at least one of the following information corresponding to the application server IP address: a data network name DNN, single network slice selection assistance information S-NSSAI, and a data network access identifier DNAI.

In some embodiments, the information about the third communication device includes at least one of the following:
an IP address, an instance identifier, a fully qualified domain name FQDN, a QoS flow identifier QFI, a PDR, and a PDU session identifier.

In some embodiments, the information about the second communication device includes at least one of the following:
an IP address, an instance identifier, and a fully qualified domain name FQDN.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, and data network performance analysis.

The apparatus in this embodiment may be configured to perform the method in any one of the foregoing method embodiments on the first communication device side. A specific implementation process and technical effects of the apparatus are similar to those of the method embodiments on the first communication device side. For details, reference may be made to the detailed description in the method embodiments on the first communication device side. Details are not described herein again.

FIG. 17 is a second schematic diagram of a structure of a data collection apparatus according to an embodiment of this application. As shown in FIG. 17, the data collection apparatus provided in this embodiment includes:
a receiving module 1701, configured to receive a first request sent by a first communication device, where the first request is used to request to obtain target data collected by a third communication device corresponding to a target terminal, and the target data is used by the first communication device to perform target processing.

The apparatus further includes a determining module 1702 and a sending module 1703. The determining module 1702 is configured to determine, based on the first request, information about the third communication device corresponding to the target terminal. The sending module 1703 is configured to: send a fourth request to the third communication device based on the information about the third communication device, where the fourth request is used to request the third communication device to collect the target data and/or obtain the target data collected by the third communication device; or send the information about the third communication device to the first communication device.

In some embodiments, the receiving module 1701 is further configured to: receive the target data sent by the third communication device, and forward the target data to the first communication device.

In some embodiments, the fourth request includes at least one of the following:
a data network name DNN, a PDU session identifier, single network slice selection assistance information S-NSSAI, an application server IP address, an analytic identifier, an event identifier, a QoS flow identifier QFI, an identifier of the target terminal, an IP address of the target terminal, and an IP address of the first communication device, where the analytic identifier and the event identifier are used to indicate a type of the collected target data, and analytic identifier corresponds to at least one event identifier.

In some embodiments, the determining module 1702 is further configured to determine, based on the first request, the information about the third communication device corresponding to the target terminal.

In some embodiments, the sending module 1703 is further configured to: send a policy generation request to a fifth communication device based on the information about the third communication device, where the policy generation request is used to request the fifth communication device to generate a target policy control rule corresponding to the third communication device, and the target policy control rule is used to indicate a type of the collected data; and send the target policy control rule to the third communication device.

In some embodiments, the determining module 1702 is further configured to determine, based on the first request, that the third communication device carries session information of the target terminal, where the session information includes at least one of the following: a packet detection rule PDR, a PDU session identifier, and a quality of service QoS flow identifier QFI.

In some embodiments, the sending module 1703 is further configured to send the session information to the third communication device, where the session information is used by the third communication device to collect the target data.

In some embodiments, the first request includes at least one of the following:
a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, and a quality of service QoS flow identifier QFI, where the analytic identifier and the event identifier are used to indicate the type of the collected target data, and the analytic identifier corresponds to at least one event identifier.

In some embodiments, the collected target data is data that is sent by a plurality of target terminals to target nodes and that is collected by the third communication device.

In some embodiments, the target nodes are a same node, and the target nodes include at least one of the following:
nodes corresponding to a same destination server IP address and nodes corresponding to a same data network DN.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, and data network performance analysis.

The apparatus in this embodiment may be configured to perform the method in any one of the foregoing method embodiments on the second communication device side. A specific implementation process and technical effects of the apparatus are similar to those of the method embodiments on the second communication device side. For details, reference may be made to the detailed description in the method embodiments on the second communication device side. Details are not described herein again.

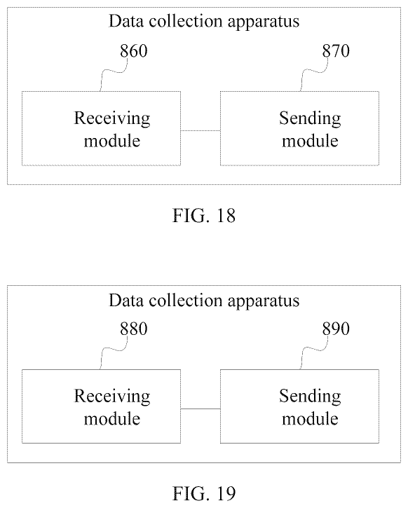

FIG. 18 is a third schematic diagram of a structure of a data collection apparatus according to an embodiment of this application. As shown in FIG. 18, the data collection apparatus provided in this embodiment includes:
a receiving module 860, configured to receive a target request, where the target request is used to request the third communication device to collect the target data and/or obtain target data collected by the third communication device, and the target data is used by a first communication device to perform target processing.

In some embodiments, the target request includes a first request sent by the first communication device, a second request sent by the first communication device, or a fourth request sent by a second communication device.

In some embodiments, the apparatus further includes:
a processing module, configured to: in a case that the target request is used to request the third communication device to collect the target data, collect, by the third communication device, the target data based on the target request; or
a sending module 870, configured to: in a case that the target request is used to request to obtain the target data collected by the third communication device, send, by the third communication device, the collected target data to the first communication device or the second communication device based on the target request.

In some embodiments, the second request includes at least one of the following:
a terminal identifier, a data network name DNN, a packet data unit PDU session identifier, single network slice selection assistance information S-NSSAI, an application server IP address, an application identifier, an analytic identifier, an event identifier, a type of the target data, a data network access identifier DNAI, a packet detection rule PDR, and a quality of service QoS flow identifier QFI, where the analytic identifier and the event identifier are used to indicate the type of the target data, and the analytic identifier corresponds to at least one event identifier.

In some embodiments, the fourth request includes at least one of the following:
a data network name DNN, a PDU session identifier, single network slice selection assistance information S-NSSAI, an application server IP address, an analytic identifier, an event identifier, a QoS flow identifier QFI, an identifier of the target terminal, an IP address of the target terminal, and an IP address of the first communication device, where the analytic identifier and the event identifier are used to indicate a type of the collected target data, and the analytic identifier corresponds to at least one event identifier.

In some embodiments, the receiving module 860 is further configured to:
receive, by the third communication device, a target policy control rule sent by the second communication device, where the target policy control rule is used to indicate a type of collected data.

In some embodiments, the receiving module 860 is further configured to:
receive, by the third communication device, session information sent by the second communication device, where the session information includes at least one of the following: a packet detection rule PDR, a PDU session identifier, and a quality of service QoS flow identifier QFI; and
collect, by the third communication device, the target data based on the session information.

In some embodiments, the processing module is configured to:
in a case that the session information includes the PDR, the collecting, by the third communication device, the target data based on the session information includes:
collecting, by the third communication device based on the PDR, target data sent by a plurality of target terminals to target nodes.

In some embodiments, the processing module is configured to:
determine, by the third communication device, a type of the target data based on an analytic identifier and/or an event identifier, where the analytic identifier and the event identifier are used to indicate the type of the target data, and the analytic identifier corresponds to at least one event identifier; and
collect, by the third communication device, the target data based on the type of the target data.

In some embodiments, the first request includes at least one of the following:
a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, and a quality of service QoS flow identifier QFI, where the analytic identifier and the event identifier are used to indicate the type of the collected target data, and the analytic identifier corresponds to at least one event identifier.

In some embodiments, the target nodes are a same node, and the target nodes are determined by using at least one of the following information:
nodes corresponding to a same destination server IP address and nodes corresponding to a same data network DN.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, and data network performance analysis.

The apparatus in this embodiment may be configured to perform the method in any one of the foregoing method embodiments on the first communication device side. A specific implementation process and technical effects of the apparatus are similar to those of the method embodiments on the first communication device side. For details, reference may be made to the detailed description in the method embodiments on the first communication device side. Details are not described herein again.

FIG. 19 is a fourth schematic diagram of a structure of a data collection apparatus according to an embodiment of this application As shown in FIG. 19, the data collection apparatus provided in this embodiment includes:
a receiving module 880, configured to receive a third request sent by a first communication device, where the third request is used to request to obtain information about a target communication device corresponding to at least one target terminal, the target communication device includes a second communication device and/or a third communication device, the information about the target communication device is used by the first communication device to obtain target data collected by a third communication device corresponding to each target terminal, and the target data is used by the first communication device to perform target processing.

In some embodiments, the apparatus further includes:
a sending module 890, configured to send the information about the target communication device to the first communication device.

In some embodiments, the third request includes at least one of the following information: terminal location information, a data network name DNN, single network slice selection assistance information S-NSSAI, a data network access identifier DNAI, an application server IP address, and a network function type.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, and data network performance analysis.

The apparatus in this embodiment may be configured to perform the method in any one of the foregoing method embodiments on the fourth communication device side. A specific implementation process and technical effects of the apparatus are similar to those of the method embodiments on the fourth communication device side. For details, reference may be made to the detailed description in the method embodiments on the fourth communication device side. Details are not described herein again.

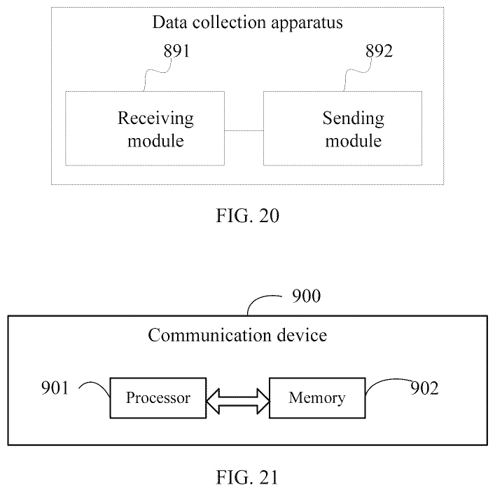

FIG. 20 is a fifth schematic diagram of a structure of a data collection apparatus according to an embodiment of this application. As shown in FIG. 20, the data collection apparatus provided in this embodiment includes:
a receiving module 891, configured to receive a policy generation request sent by a second communication device, where the policy generation request is used to request the fifth communication device to generate a target policy control rule corresponding to a third communication device, and the target policy control rule is used to indicate a type of collected data; and
a sending module 892, configured to send the target policy control rule corresponding to the third communication device to the second communication device.

In some embodiments, the policy generation request is sent after the second communication device receives a first request sent by a first communication device, the first request is used to request to obtain target data collected by a third communication device corresponding to a target terminal, and the target data is used by the first communication device to perform target processing.

In some embodiments, the first request includes at least one of the following:
a terminal identifier, a data network name DNN, a packet data unit PDU session identifier, single network slice selection assistance information S-NSSAI, an application identifier, an analytic identifier, an event identifier, a type of the target data, a data network access identifier DNAI, a packet detection rule PDR, and a quality of service QoS flow identifier QFI, where the analytic identifier and the event identifier are used to indicate the type of the collected target data, and the analytic identifier corresponds to at least one event identifier.

In some embodiments, the target processing includes at least one of the following:
network data analysis related to a slice load level, network data analysis related to observed service experience, network function load analysis, network performance analysis, terminal mobility analysis, terminal communication analysis, network data analysis related to an expected terminal behavior parameter, network data analysis related to abnormal behavior, user data congestion analysis, QoS sustainability analysis, deviation analysis, WLAN performance analysis, session management congestion control experience analysis, analysis related to redundancy transmission experience, and data network performance analysis.

The apparatus in this embodiment may be configured to perform the method in any one of the foregoing method embodiments on the fifth communication device side. A specific implementation process and technical effects of the apparatus are similar to those of the method embodiments on the fifth communication device side. For details, reference may be made to the detailed description in the method embodiments on the fifth communication device side. Details are not described herein again.

The data collection apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. Another device may be a server, a Network Attached Storage (NAS), or the like. This is not specifically limited in this embodiment of this application.

The data collection apparatus provided in this embodiment of this application can implement the processes in the method embodiments in FIG. 2 to FIG. 15, and a same technical effect is achieved. To avoid repetition, details are not described herein again.

In some embodiments, as shown in FIG. 21, an embodiment of this application further provides a communication device 900, including a processor 901 and a memory 902, and the memory 902 stores a program or an instruction that can be run on the processor 901. For example, in a case that the communication device 900 is a network side device, the program or the instruction is executed by the processor 901 to implement the steps of the foregoing embodiments of the data collection method, and a same technical effect can be achieved. To avoid repetition, details are not described herein again.

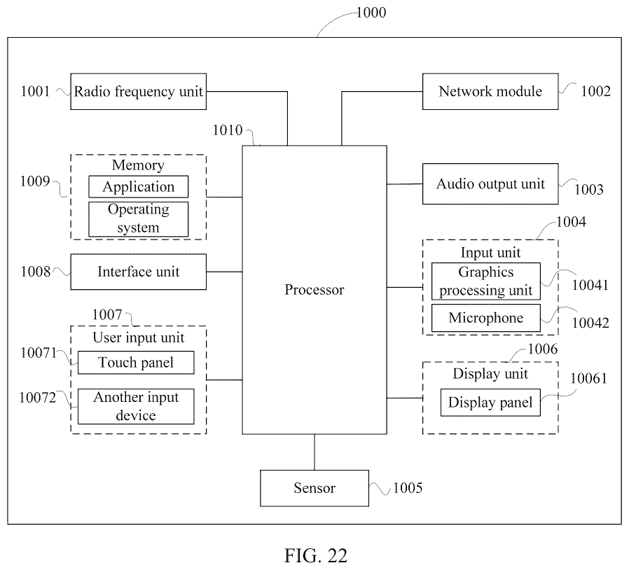

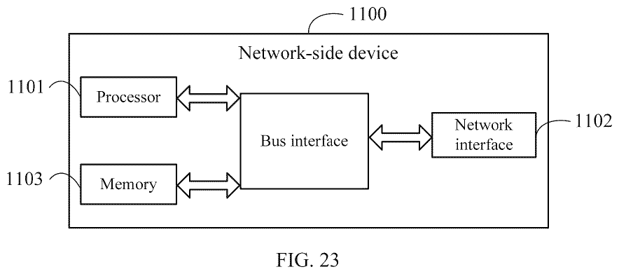

An embodiment of this application further provides a terminal, including a processor and a communication interface. FIG. 22 is a schematic diagram of a hardware structure of a terminal according to an embodiment of this application.

The terminal 1000 includes but is not limited to at least some components in a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 22 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include, but is not limited to, a physical keyboard, a function key (such as a volume control key or an on/off key), a trackball, a mouse, and a joystick. Details are not described herein again.

In this embodiment of this application, the radio frequency unit 1001 receives downlink data from a network side device and then sends the downlink data to the processor 1010 for processing; and the radio frequency unit 1001 may send uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area for the program or the instruction may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The memory 1009 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 1009 in this embodiment of this application includes but is not limited to these memories and any memory of another proper type, for example, at least one disk storage device, a flash memory device, or other non-volatile solid state storage devices.

The processor 1010 may include one or more processing units. In some embodiments, an application processor and a modem processor may be integrated into the processor 1010. The application processor mainly processes an operating system, a user interface, an application or instruction, or the like. The modem processor mainly processes a wireless communication signal, for example, a baseband processor. It may be understood that, the modem processor may not be integrated into the processor 1010.

An embodiment of this application further provides a network side device, including a processor and a communication interface. The communication interface is configured to send a first request to a target communication device. The first request is used to request to obtain target data collected by a third communication device corresponding to a target terminal. The target data is used by a first communication device to perform target processing. The processor is configured to obtain the target data collected by the third communication device. This embodiment of the network side device is corresponding to the foregoing method embodiment on the first communication device side. Each implementation process and implementation manner of the foregoing method embodiment may be applicable to this embodiment of the network side device, and a same technical effect can be achieved.

An embodiment of this application further provides a network side device, including a processor and a communication interface. The communication interface is configured to receive a first request sent by a first communication device. The first request is used to request to obtain target data collected by a third communication device corresponding to a target terminal. The target data is used by the first communication device to perform target processing. This embodiment of the network side device is corresponding to the foregoing method embodiment on the second communication device side. Each implementation process and implementation manner of the foregoing method embodiment may be applicable to this embodiment of the network side device, and a same technical effect can be achieved.

An embodiment of this application further provides a network side device, including a processor and a communication interface. The communication interface is configured to receive a target request. The target request is used to request a third communication device to collect target data and/or obtain target data collected by the third communication device. The target data is used by a first communication device to perform target processing. This embodiment of the network side device is corresponding to the foregoing method embodiment on the third communication device side. Each implementation process and implementation manner of the foregoing method embodiment may be applicable to this embodiment of the network side device, and a same technical effect can be achieved.

An embodiment of this application further provides a network side device, including a processor and a communication interface. The communication interface is configured to receive a third request sent by a first communication device. The third request is used to request to obtain information about a target communication device corresponding to at least one target terminal, and the target communication device includes a second communication device and/or a third communication device. Information about the target communication device is used by the first communication device to obtain target data collected by a third communication device corresponding to each target terminal. The target data is used by the first communication device to perform target processing. This embodiment of the network side device is corresponding to the foregoing method embodiment on the fourth communication device side. Each implementation process and implementation manner of the foregoing method embodiment may be applicable to this embodiment of the network side device, and a same technical effect can be achieved.

An embodiment of this application further provides a network side device, including a processor and a communication interface. The communication interface is configured to receive a policy generation request sent by a second communication device. The policy generation request is used to request a fifth communication device to generate a target policy control rule corresponding to a third communication device, and the target policy control rule is used to indicate a type of collected data. The processor is configured to send the target policy control rule corresponding to the third communication device to the second communication device. This embodiment of the network side device is corresponding to the foregoing method embodiment on the fifth communication device side. Each implementation process and implementation manner of the foregoing method embodiment may be applicable to this embodiment of the network side device, and a same technical effect can be achieved.

An embodiment of this application further provides a network side device. As shown in FIG. 23, a network side device 1100 includes a processor 1101, a network interface 1102, and a memory 1103. The network interface 1102 is, for example, a common public radio interface (CPRI).

The network side device 1100 in this embodiment of this application further includes an instruction or a program that is stored in the memory 1103 and that can be run on the processor 1101, and the processor 1101 invokes the instruction or the program in the memory 1103 to perform the methods performed by the modules shown in FIG. 16 to FIG. 20, and a same technical effect is achieved. To avoid repetition, details are not described herein again.

The network side device is, for example, at least one of the following: a first communication device, a second communication device, a third communication device, a fourth communication device, or a fifth communication device.

An embodiment of this application further provides a readable storage medium. The readable storage medium stores a program or an instruction, and when the program or the instruction is executed by a processor, the processes of the foregoing embodiments of the data collection method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiments of the data collection method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the data collection method, and a same technical effect can be achieved. To avoid repetition, details are not described herein again.

An embodiment of this application further provides a communication system, including a first communication device, a second communication device, a third communication device, a fourth communication device, and a fifth communication device. The first communication device, the second communication device, the third communication device, the fourth communication device, and the fifth communication device may be separately configured to perform the steps of the foregoing data collection methods.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A data collection method, comprising:
sending, by a first communication device, a first request to a target communication device, wherein the first request is used to request to obtain target data collected by a third communication device corresponding to a target terminal, and the target data is used by the first communication device to perform target processing; and
obtaining, by the first communication device, the target data collected by the third communication device.

2. The data collection method according to claim 1, wherein when the target communication device is a second communication device, the method further comprises:
receiving, by the first communication device, information about the third communication device that is sent by the second communication device; and
sending, by the first communication device, a second request to the third communication device based on the information about the third communication device, wherein the second request is used to request the third communication device to collect the target data or obtain the target data collected by the third communication device; and
when the second request is used to request to obtain the target data collected by the third communication device, the obtaining, by the first communication device, the target data collected by the third communication device comprises:
receiving, by the first communication device, the collected target data sent by the third communication device.

3. The data collection method according to claim 1, wherein when the target communication device is a second communication device, the obtaining, by the first communication device, the target data collected by the third communication device comprises:
receiving, by the first communication device, the collected target data sent by the third communication device; or
receiving, by the first communication device, the target data sent by the second communication device and collected by the third communication device.

4. The data collection method according to claim 1, wherein when the target communication device is the third communication device, the obtaining, by the first communication device, the target data collected by the third communication device comprises:
receiving, by the first communication device, the collected target data sent by the third communication device.

5. The data collection method according to claim 1, wherein when the target communication device is the third communication device, the first request is further used to request the third communication device to collect the target data.

6. The data collection method according to any one of claim 1, wherein the first request comprises at least one of the following:
a terminal identifier, a data network name (DNN), a packet data unit (PDU) session identifier, single network slice selection assistance information (S-NSSAI), an application identifier, an analytic identifier, an event identifier, a type of the target data, a data network access identifier (DNAI), a packet detection rule (PDR), or a quality of service (QoS) flow identifier (QFI), wherein the analytic identifier and the event identifier are used to indicate the type of the collected target data, and the analytic identifier corresponds to at least one event identifier.

7. The data collection method according to claim 2, wherein the second request comprises at least one of the following:
a terminal identifier, a data network name (DNN), a packet data unit (PDU) session identifier, single network slice selection assistance information (S-NSSAI), an application server IP address, an application identifier, an analytic identifier, an event identifier, a type of the target data, a data network access identifier (DNAI), a packet detection rule (PDR), or a quality of service (QoS) flow identifier QFI, wherein the analytic identifier and the event identifier are used to indicate a type of the collected target data, and the analytic identifier corresponds to at least one event identifier.

8. The data collection method according to claim 1, wherein when there are a plurality of target terminals, before the sending, by the first communication device, the first request to the second communication device, the method further comprises:
sending, by the first communication device, a third request to a fourth communication device, wherein the third request is used to request to obtain information about target communication devices corresponding to the plurality of target terminals, and the target communication devices comprise the second communication device or the third communication device.

9. The data collection method according to claim 8, wherein the third request comprises at least one of the following information: terminal location information, a data network name (DNN), single network slice selection assistance information (S-NSSAI), a data network access identifier (DNAI), an application server IP address, or a network function type.

10. The data collection method according to claim 2, wherein the information about the third communication device comprises at least one of the followings:
an IP address, an instance identifier, a fully qualified domain name (FQDN), a quality of service (QoS) flow identifier (QFI), a packet detection rule (PDR), or a PDU session identifier.

11. A data collection method, comprising:
receiving, by a second communication device, a first request sent by a first communication device, wherein the first request is used to request to obtain target data collected by a third communication device corresponding to a target terminal, and the target data is used by the first communication device to perform target processing.

12. The data collection method according to claim 11, further comprising:
determining, by the second communication device based on the first request, information about the third communication device corresponding to the target terminal; and
sending, by the second communication device, a fourth request to the third communication device based on the information about the third communication device, wherein the fourth request is used to request the third communication device to collect the target data or obtain the target data collected by the third communication device; or
sending, by the second communication device, the information about the third communication device to the first communication device.

13. The data collection method according to claim 12, further comprising:
receiving, by the second communication device, the target data sent by the third communication device, and forwarding the target data to the first communication device.

14. The data collection method according to claim 12, wherein the fourth request comprises at least one of the following:
a data network name (DNN), a packet data unit (PDU) session identifier, single network slice selection assistance information (S-NSSAI), an application server IP address, an analytic identifier, an event identifier, a quality of service (QoS) flow identifier (QFI), an identifier of the target terminal, an IP address of the target terminal, or an IP address of the first communication device, wherein the analytic identifier and the event identifier are used to indicate a type of the collected target data, and the analytic identifier corresponds to at least one event identifier.

15. The data collection method according to claim 11, further comprising:
determining, by the second communication device based on the first request, the information about the third communication device corresponding to the target terminal;
sending, by the second communication device, a policy generation request to a fifth communication device based on the information about the third communication device, wherein the policy generation request is used to request the fifth communication device to generate a target policy control rule corresponding to the third communication device, and the target policy control rule is used to indicate a type of the collected data; and
sending, by the second communication device, the target policy control rule to the third communication device.

16. The data collection method according to claim 15, further comprising:
determining, by the second communication device based on the first request, that the third communication device carries session information of the target terminal, wherein the session information comprises at least one of the following: a packet detection rule (PDR), a packet data unit (PDU) session identifier, or a quality of service (QoS) flow identifier (QFI); and
sending, by the second communication device, the session information to the third communication device, wherein the session information is used by the third communication device to collect the target data.

17. The data collection method according to claim 11, wherein the first request comprises at least one of the following:
a terminal identifier, a data network name (DNN), a packet data unit (PDU) session identifier, single network slice selection assistance information (S-NSSAI), an application identifier, an analytic identifier, an event identifier, a type of the target data, a data network access identifier (DNAI), a packet detection rule (PDR), and a quality of service (QoS) flow identifier (QFI), wherein the analytic identifier and the event identifier are used to indicate the type of the collected target data, and the analytic identifier corresponds to at least one event identifier.

18. The data collection method according to claim 11, wherein the collected target data is data that is sent by a plurality of target terminals to target nodes and that is collected by the third communication device.

19. A data collection method, comprising:
receiving, by a fourth communication device, a third request sent by a first communication device, wherein the third request is used to request to obtain information about a target communication device corresponding to at least one target terminal, the target communication device comprises a second communication device or a third communication device, the information about the target communication device is used by the first communication device to obtain target data collected by a third communication device corresponding to each target terminal, and the target data is used by the first communication device to perform target processing.

20. The data collection method according to claim 19, wherein the third request comprises at least one of the following information: terminal location information, a data network name (DNN), single network slice selection assistance information (S-NSSAI), a data network access identifier (DNAI), an application server IP address, and a network function type.
